(19) United States
(12) Patent Application Publication
(10) Pub. No.: US 2024/0226888 A1
(43) Pub. Date: Jul. 11, 2024

(54) MICROFLUIDIC FLOW CELL ARRAYS

(71) Applicant: Carterra, Inc., Salt Lake City, UT (US)

(72) Inventors: Bruce Kent GALE, Taylorsville, UT (US); James SMITH, Bountiful, UT (US); Joshua ECKMAN, Woods Cross, UT (US); Viatcheslav PETROPAVLOVSKIKH, Louisville, CO (US); Brady GOENNER, Salt Lake City, UT (US)

(21) Appl. No.: 18/410,163

(22) Filed: Jan. 11, 2024

Related U.S. Application Data
(60) Provisional application No. 63/438,329, filed on Jan. 11, 2023.

(51) Int. Cl. B01L 3/00

(52) U.S. Cl. CPC B01L 3/50273; B01L 3/502715; B01L 2200/04; B01L 2300/0654; B01L 2300/0874; B01L 2300/161; B01L 2400/084

(57) ABSTRACT

A microfluidic flow cell array can include a fluid directing body with multiple layers of three-dimensionally printed material defining a first pair of microfluidic channels that individually transect a portion of the multiple layers and also redirect fluid flow when within the fluid directing body, and a second pair of microfluidic channels that individually transect a portion of the multiple layers and also redirect fluid flow when within the fluid directing body. The contact deposition seal can be adapted to contact a deposition surface and deliver fluid thereto, and can define a first flow chamber and a second flow chamber. The first flow chamber can be fluidly coupled to adjacent terminating ends of the first pair of microfluidic channels forming a first flow cell. The second flow chamber can be fluidly coupled to adjacent terminating ends of the second pair of microfluidic channels forming a second flow cell.

The present application claims the benefit of U.S. Provisional Patent Application No. 63/438,329, filed on Jan. 11, 2023, the entirety of which is incorporated herein by reference.

### BACKGROUND

Biomolecular interaction sensing and imaging systems are used by researchers in the academic, pharmaceutical, and biotechnology sectors to observe, evaluate, and/or characterize binding interactions, e.g., antibody characterization, proteomics, vaccines, immunogenicity, biopharmaceutical development and production, etc. Numerous commercial biosensor instruments based on microarray approaches are available, including label-free biosensor and flow-through cell instruments, as well as other “printing” systems, e.g., pin printing, piezo printing, and microfluidic array printing. In some systems, after applying the material(s) of interest on a substrate (ligand or similar substance), the sample (analyte) is loaded onto the biosensor where a binding interaction between the ligand and the sample occurs which can be further evaluated or characterized, or alternatively, no binding is observed which can be noted. In other systems, the printing is done in the instrument and then the binding analyte is delivered to the printed spots using the same flow cell arrays and the binding reaction is observed.

### BRIEF DESCRIPTION OF THE DRAWINGS

FIG. 1A illustrates an example three-dimensional printing system that can be used to prepare an example microfluidic flow cell array in accordance with the present disclosure;

FIG. 1B illustrates another example three-dimensional printing system that can be used to prepare an example microfluidic flow cell array in accordance with the present disclosure:

FIG. 2A is a schematic cross-sectional view of an example flow cell applicator system with multiple flow cell applicators, e.g., a microfluidic flow cell array (MFCA) and a single large flow cell applicator in accordance with the present disclosure;

FIG. 2B is a perspective view of a portion of the flow cell applicator system of FIG. 2A with example arrays of spots printed in various configurations on an assay surface of a bio-sensor, as well as a few example large spots applied over (or under) some of the arrays of spots;

FIG. 3 illustrates multiple views of an example microfluidic flow cell array that can be prepared using three-dimensional printing in accordance with examples of the present disclosure;

FIG. 4 illustrates multiple views of another example microfluidic flow cell array that can be prepared using three-dimensional printing in accordance with examples of the present disclosure;

FIG. 5 illustrates a top view of an example microfluidic flow cell array positioned within a cartridge configured to interface with a flow cell applicator system in accordance with the present disclosure.

FIGS. 6A-6C illustrate multiple example three-dimensional printing build orientations and features in accordance with the present disclosure:

FIG. 7 is an image of an example 16 channel microfluidic flow cell array viewed from its contact deposition seal pressed against a sensor surface, in accordance with the present disclosure;

FIG. 8 is a graph illustrating example data collected from the 16 evenly spaced regions of interest (ROI) showing fluid flow through microfluidic channels prepared by three-dimensional printing in accordance with the present disclosure;

FIG. 9 is a graph illustrating example data collected from the 16 evenly spaced ROI showing fluid flow through microfluidic channels prepared by three-dimensional printing in accordance with the present disclosure; and

FIG. 10 is a graph illustrating example data collected from the 287 ROI showing fluid flow through microfluidic channels prepared by three-dimensional printing in accordance with the present disclosure.

### DETAILED DESCRIPTION

In accordance with examples herein, the present disclosure provides microfluidic flow cell arrays, systems utilizing microfluidic flow cell arrays, and methods of manufacture and use of microfluidic flow cell arrays for high throughput binding reaction observations, evaluations, characterization, etc. A “microfluidic flow cell array” (MFCA) is defined herein to include a support body, often made of polymeric material(s), that define multiple flow cells therein. Microfluidic flow cell arrays can be referred to synonymously as multi-flow cell applicators, as there are multiple flow cells that apply multiple spots of fluid(s). There can be multiple structures joined together to form the support body of the microfluidic flow cell array, e.g., a fluid directing body and a contact deposition seal. “Flow cells” are defined herein to include at least a pair of microfluidic channels which are fluidly coupled to a flow chamber therebetween. Thus, a “microfluidic flow cell array” includes multiple pairs of microfluidic channels and multiple flow chambers individually fluidly coupled to individual pairs of microfluidic channels, whereas a “large flow cell” includes a pair of microfluidic channels fluidly coupled to a large flow chamber therebetween. The term “large” is relative, meaning it is large enough to cover multiple spots deposited by a microfluidic flow cell array.

Furthermore, when referring to a “flow chamber” of a flow cell, this chamber is typically in the form of an open cavity defined at its open end by a contact deposition seal. The microfluidic channels provide fluid ingress and egress to the flow chamber, and the contact deposition seal surrounding the open cavity is pressed against a deposition surface for any of a number of fluid flow purposes. In some instances, the flow chamber may act as a “deposition chamber,” where substances passing therethrough are deposited on the deposition surface. In other examples the flow channel may act as a “washing chamber” or a “substance removal chamber,” and thus, is not always used for substance application to the deposition surface. In each use scenario, however, fluid is flowed into and out of the flow chamber, and thus, the term “flow chamber” adequately describes each of these various types of uses. Even in instances where the fluid might temporarily be held stagnant within the flow chamber against the deposition surface, e.g., soaking the deposition surface or simply pausing between flows, there would still be fluid flow before or after such a fluid hold within the flow chamber.

In accordance with this, in some examples, a microfluidic flow cell array defining a plurality of flow cells can include a fluid directing body with multiple layers of three-dimensionally printed material. The fluid directing body can define a first pair of microfluidic channels that individually transect a portion of the multiple layers and also redirect fluid flow when within the fluid directing body, and a second pair of microfluidic channels that individually transect a portion of the multiple layers and also redirect fluid flow when within the fluid directing body. The microfluidic flow cell array can also include a contact deposition seal adapted to contact a deposition surface and deliver fluid thereto without leaking. The contact deposition seal can define a first flow chamber and a second flow chamber. The first flow chamber can be fluidly coupled to adjacent terminating ends of the first pair of microfluidic channels forming a first flow cell, and a second flow chamber can be fluidly coupled to adjacent terminating ends of a second pair of microfluidic channels forming a second flow cell.

In another example, a flow cell applicator system can include a microfluidic flow cell array defining a plurality of flow cells and a fluid applicator assembly couplable or coupled to the microfluidic flow cell array to deliver fluid to a deposition surface through the microfluidic flow cell array. The microfluidic flow cell array can include a fluid directing body and a contact flow chamber. The fluid directing body can include multiple layers of three-dimensionally printed material, can define a first pair of microfluidic channels that individually transect a portion of the multiple layers and also redirect fluid flow when within the fluid directing body, and can also define a second pair of microfluidic channels that individually transect a portion of the multiple layers and also redirect fluid flow when within the fluid directing body. The contact deposition seal can be adapted to contact a deposition surface and deliver fluid thereto. The contact deposition seal can define, for example, a first flow chamber and a second flow chamber. The first flow chamber can be fluidly coupled to adjacent terminating ends of the first pair of microfluidic channels forming a first flow cell. The second flow chamber can be fluidly coupled to adjacent terminating ends of the second pair of microfluidic channels forming a second flow cell.

In another example, a method of manufacturing a microfluidic flow cell array can include forming at least a portion of the microfluidic flow cell array by a three-dimensional printing method. The microfluidic flow cell array can define at least two flow cells. Furthermore, individual flow cells, including at least two flow cells, include a pair of microfluidic channels and a flow chamber fluidly coupled to adjacent terminating ends of the pair of microfluidic channels. In some examples, the microfluidic flow cell array may include a fluid directing body that defines the multiple pairs of microfluidic channels, and also may include a contact deposition seal that defines multiple corresponding flow chambers. The fluid directing body can be formed by the three-dimensional printing, and the contact deposition seal may or may not be formed by three-dimensional printing. If both are formed by three-dimensional printing, they can be formed separately and joined together, or can be formed as one continuous three-dimensional printing process (or two separate three-dimensional printing process but done successively so that an adhesive may not be needed to join the two structures together). The three-dimensional printing process may include, for example, application of multiple materials such that the microfluidic flow cell array has discrete portions of individual materials of the multiple materials. In some examples, there may be a cartridge that carries the microfluidic flow cell array that interfaces with the flow cell applicator system as a whole. The cartridge may likewise be prepared by three-dimensional printing, or may be prepared by other manufacturing processes.

It is noted that when discussing the microfluidic flow cell arrays, systems, and/or methods herein, these discussions are considered applicable to other examples whether or not they are explicitly discussed in the context of that example unless expressly indicated otherwise. Thus, for example, when discussing a certain type of material in the context of the microfluidic flow cell array, such disclosure is also relevant to and directly supported in context of the other example microfluidic flow cell arrays, systems, and/or methods, and vice versa. Furthermore, for simplicity and illustrative purposes, numerous specific details are set forth in order to provide a thorough understanding of the present disclosure. It will be readily apparent however, that the present disclosure can be practiced without limitation to some of these specific details. In other instances, certain methods, systems, materials, and structures have not been described in detail so as not to obscure the present disclosure.

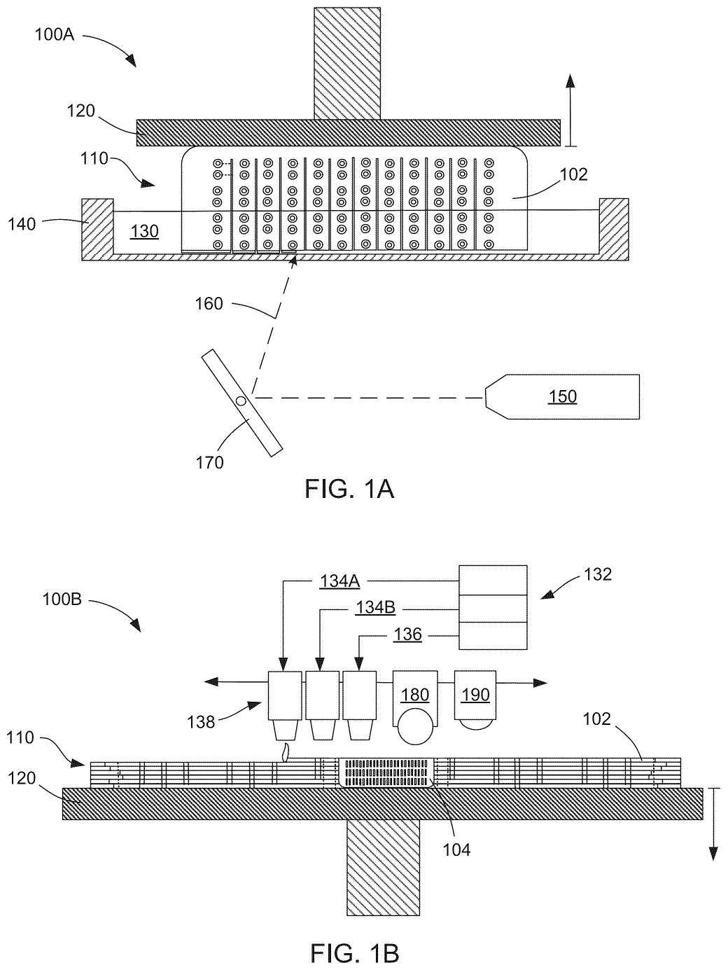

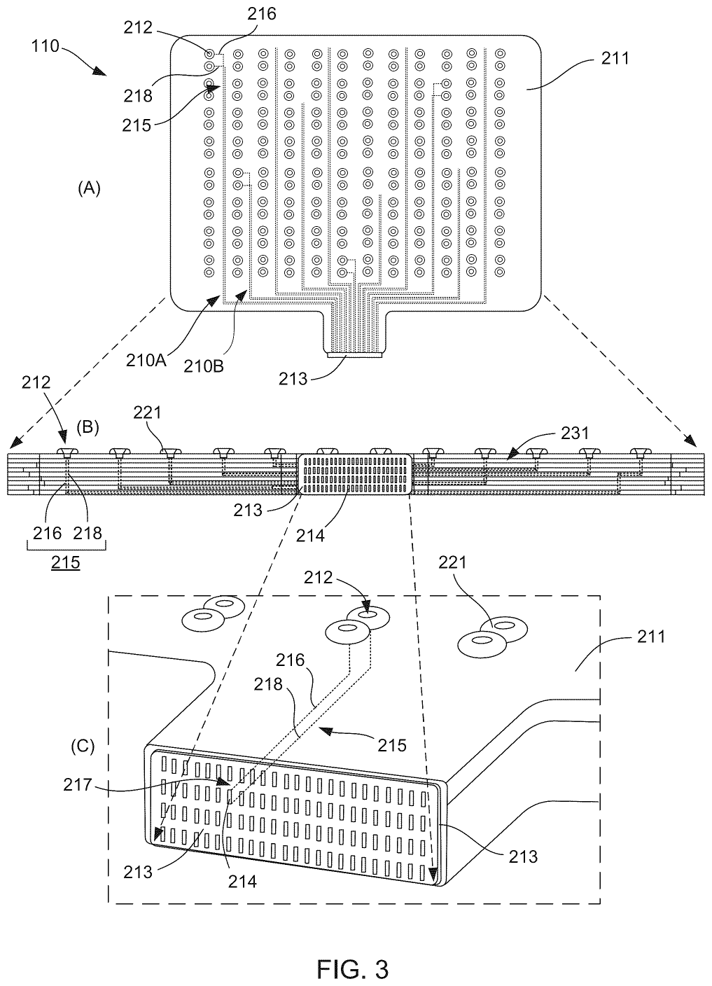

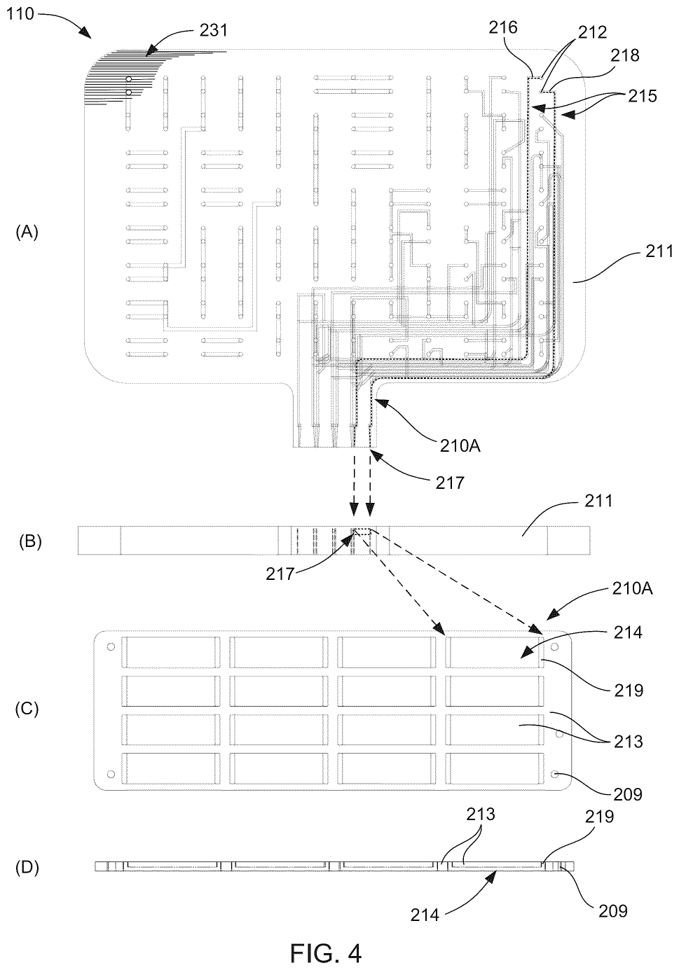

Referring now to FIG. 1A, an example method of three-dimensionally printing a microfluidic flow cell array is shown. In this example, a stereolithography (SLA) three-dimensional printing system 100A is shown. Specifically, a top-down printer is shown, but a bottom-up three-dimensional SLA printer could likewise be used to form a microfluidic flow cell array 110, e.g., with the laser and mirror optics positioned above a submerged part. As a “top-down” SLA printer, a build platform 120 is temporarily fused with a layer of the microfluidic flow cell array, which hangs therefrom. A photo-curable component 130, e.g., UV-curable resin, is contained by a tank 140 or container, and the photo-curable component becomes cured in a layer-by-layer basis using a laser 150 which emits a laser beam 160 having wavelength and power concentration suitable for curing the photo-curable component, e.g., a UV laser may be used to cure a UV-curable resin. In some examples, there may be lenses or other optics not shown. A movable mirror 170 that provides XY coordination of the laser beam through the resin tank is used to selectively fuse the photo-curable component to a previously printed layer as a solidified cured polymeric mass. This process is repeated in a layer-by-layer manner until the part is built. If the part being built is to include multiple types of materials, a second curable resin and resin tank can be used to add additional layers of a different material. For example, a first photo-curable component may be used to build a fluid directing body 102, which is shown as partially built in this FIG. However, when it is time to add the contact deposition seal (not shown, but shown at 213 in FIGS. 3 and 4), a different photo-curable component that provides a different property can be used, e.g., softness, elasticity, electrical conductivity, refractive index, thermal conductivity or heat capacity, etc. In other examples, the contact deposition seal may be manufactured by another three-dimensional printing process, or by any other fabrication process and then joined with the fluid directing body prepared as shown in FIG. 1A, for example.

Referring now to FIG. 1B, another example method of three-dimensionally printing a microfluidic flow cell array is shown. More specifically, a polyjet three-dimensional printing system 100B is used that relies on fluidic photo-curable material that is applied in a layer-by-layer basis, building the part from the bottom-up in this instance. The microfluidic flow cell array 110 being formed is built on a build platform 120. As the layers of build material are applied, the individual layers can be photo-cured (depending on the material selected for use). Photo curing can occur, for example, by emitting a wavelength of light from a photo-lamp 190 matched to cure the build material layers as they are applied. In some examples, a roller 180 may be used periodically on some or all layers to smooth out the layers during the print process. As shown in this example, there can be supply cartridges 132 and corresponding fluid ejectors 136 (or extruders in some examples where the material is more suitable for extrusion), which are in the form of an off-axis printer arrangement. However, in other examples, the supply cartridges and the fluid ejectors may be integrated together in an on-axis arrangement. Either way, a first build material 134A can be applied to form a portion of the microfluidic flow cell array of a first material. Likewise, a second build material 134B can be applied to another portion of the microfluidic flow cell array where a material having a different property may be beneficial, e.g., different stiffness/softness, optical absorbance/refractive index, thermal conductivity/heat capacity, etc.

With three-dimensional printing in this example, negative space can be preserved in the final part by printing support material 136 that is capable of being readily removed after the part is completed, or after a portion of the part is completed. For example, to retain microfluidic flow channels within the body of the fluid directing body 102, or to retain flow chambers or open cavities in the contact deposition seal, support material can be used at those locations and then removed after the part is cured or otherwise solidified. Examples of support material that may be used include any of a number of sacrificial materials that can be cleared out leaving negative space for operation of the microfluidic flow channel array. Example sacrificial materials can be water-soluble materials, solvent-soluble materials, phase-changing materials, gel or viscous liquid materials, e.g., filling channels during the printing to be flowed therefrom upon opening channels mechanically, shear thinning materials, e.g., applying pressure to change viscosity to remove sacrificial material, etc.

It is noted that there are other three-dimensional printing technologies that can be used other than SLA printing or polyjet printing as described above. Examples include Digital Light Process (DLP) printing, Selective Laser Sintering (SLA), Fused Deposition Modeling (FDM), Direct Metal Layer Sintering (DMLS), Electron Beam Melting (EBM), Binder Jetting, e.g., printing metals ceramics, etc. to form green parts for subject sintering, Powder Bed Fusion (PBF), Directed Energy Deposition (DED), and/or Sheet Lamination (SL), depending on the part being prepared. For example, a metal thermally conductive part could be prepared using DMLS. Depending on the type of three-dimensional printing that occurs, different structures may be used. For example, some printing technologies may utilize lasers to cure a layer of a polymeric material, and other printing technologies may not selectively cure, but rather use other types of energy sources, e.g., LEDs, super-LEDs, heating lamps, flash heating devices, etc.

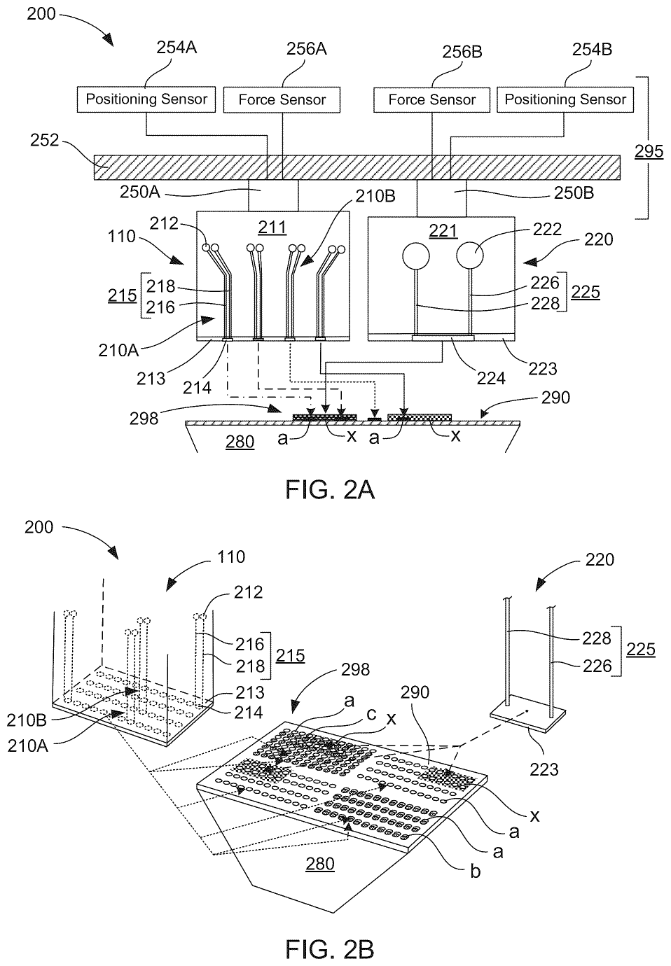

Referring now to FIGS. 2A and 2B, a schematic example is shown of a flow cell applicator system 200 consistent with the teachings of the present disclosure. More specifically, FIG. 2A shows various mechanisms 250A-256B of the system as well as schematic cross-sectional views taken through four flow cells of a microfluidic flow cell array 110 and a schematic cross-sectional view taken through a large flow cell applicator 220. FIG. 2A also shows an example application surface 290, which in this instance is a surface plasmon resonance application surface, which is an upper surface (or coating thereof) of a solid optical material 280, e.g., optical prism. FIG. 2B shows a perspective view of both the microfluidic flow cell array and the large flow cell applicator as they may be used on the application surface by way of example.

In this example, microfluidic flow cell array 110 (or multi-flow cell applicator) can include a first flow cell 210A, a second flow cell 210B, and a plurality of additional flow cells for depositing an array of spots 298 (shown in cross section in FIG. 2A with 4 flow cells showing, but which are each aligned with 11 other flow cells in the z-direction and not visible in FIG. 2A, but visible in the perspective view of FIG. 2B). Thus, in this example, the microfluidic flow cell array provides a total of 48 flow cells (or fluidic circuits), which includes the first flow cell 210A and the second flow cell 210B as shown by way of example. The first flow cell, the second flow cell, and the other 46 flow cells shown in this example can be individually defined by a fluid directing body 211 and a contact deposition seal 213. The fluid directing body and the contact deposition seal can be two different structures that are joined together, or these two structures may be two portions of a unitary structure. For example, the fluid directing body may be three-dimensionally printed and the contact deposition seal may be fabricated separately (by three-dimensional printing or otherwise) and joined with the fluid directing body by adhesion, heat fusion, or other methodology of joining two materials together. Alternatively, the fluid directing body and the contact deposition seal may be three-dimensionally printed as part of a continuous three-dimensional printing process using the same or different materials, for example.

In this example, microfluidic flow cell array 110 includes the fluid directing body 211 that can be prepared by three-dimensional printing and can define multiple flow cells, including a first flow cell 210A and a second flow cell 210B. The other flow cells are not specifically notated, but in this example, there are an additional 47 flow cells that can be arranged similarly or in a different configuration, including the second flow cell having a similar structure. The fluid directing body can define a first pair of microfluidic channels 215, including individual microfluidic channels 216 and 218. The individual microfluidic channels in this example each include a source fluid opening 212 or ports, which is where fluid is introduced and/or exits the individual microfluidic channels during operation. Thus, the term “source fluid opening” is not limited to the introduction of fluid into the flow cell, but rather the location where fluid is introduced or exits the flow cell. Thus, a source fluid opening may be a location of ingress into (an inlet) or egress out of (an outlet) a microfluidic channel of a flow cell. As some flow cells use bidirectional flow, source fluid openings may act as both inlets and outlets at different periods of time during operation in some examples. In other instances, fluid may be introduced into one of the two source fluid openings where fluid only exits the other of the two source fluid openings. With this background, the source fluid opening(s) can be, for example, simply the ends of the individual microfluidic channels that are distal to the contact deposition seal 213, or the source fluid openings can likewise be associated with more elaborate structures at the source fluid openings, e.g., integrated fluid wells, luer connectors, removable plugs, pipette adaptors (to accept pipette tips), syringe adaptors (to accept syringe tip), needle adaptors, fluidic through-holes, nanoport assemblies, fluidic seals or valves coupled to fluid vessels, bulk fluidic ports, air control ports, fluid sample ports, waste ports, etc. Regardless of how the fluid is introduced and/or returned, or even bi-directionally flowed through the flow chamber via the pair of microfluidic channels, fluid introduction and fluid return or venting can be carried out using this flow cell arrangement.

In further detail, as shown, the individual microfluidic channels 216 and 218 can be configured to change in direction so that at least a portion of the individual microfluidic channels transect multiple layers of the three-dimensionally printed fluid directing body 211. For example, if a lower portion of the first pair of microfluidic channels (more proximal to the contact deposition seal 213) are oriented in alignment with the three-dimensionally printed layers, then the angled upper portion of the microfluidic channels (more proximal to the source fluid openings 212) would transect multiple printed layers.

In further detail, the microfluidic flow cell array 110 can include the contact deposition seal 213, which defines a first flow chamber 214. The other flow chambers of the other flow cells are not specifically notated, but in this example, there are an additional 47 flow cells with flow chambers, including the second flow chamber of the second flow cell 210B, that can be arranged similarly or in a different configuration. The contact deposition seal can be adapted to contact a deposition surface 290 and deliver fluid thereto in the form of an array of spots 298. Thus, the contact deposition seal can define a first flow chamber (of the first flow cell), a second flow chamber (of the second flow cell), and a plurality of other flow chambers as part of their individual flow cell circuits. The first flow chamber can be fluidly coupled to adjacent terminating ends (opposite the source fluid openings) of the first pair of microfluidic channels forming a first flow cell, and the second flow chamber can be fluidly coupled to adjacent terminating ends (opposite the source fluid openings) of the second pair of microfluidic channels forming a second flow cell. The terminating ends are not shown in this example, but are shown more clearly at 217 in FIG. 4.

In this example, in addition to the microfluidic flow cell array 110, there may be a second flow cell applicator. This can also be a microfluidic flow cell array, but in this instance as shown, the other flow cell application is a large flow cell applicator 220 that is used to provide a single spot. In this example, the large flow cell applicator includes a fluid directing body 221 that defines a pair of microfluidic channels 225, including individual microfluidic channels 226 and 228, and a pair of corresponding source fluid openings 222. The large flow cell applicator also includes a contact deposition seal 223 that defines a single flow chamber 224. The large flow cell applicator can likewise be formed using a three-dimensional printing process, including the fluid directing body and/or the contact deposition seal. These two structures can be formed separately and joined together as previously described, or they can be formed as a single unitary unit by three-dimensional printing using a single material or multiple materials.

In the particular embodiment shown, the flow cell applicator system 200 can be a continuous flow cell applicator system, for example. Thus, the microfluidic flow cell array 110 can have multiple respective flow cells 210A, 210B, etc., or flow circuits (up to 48 total flow cells in this example), where fluid is introduced into a source fluid opening 212, flows through microfluidic channel 216, across the flow chamber, and then out through microfluidic channel 218 (in some instances out the other source fluid opening).

It is notable that there are four separate flow paths shown in FIG. 2A, and only one “first” flow cell is fully labeled, but the other three flow paths can be operated and implemented similar to that shown and described with respect to the first flow path and associated structure. Furthermore, when viewed from a perspective view in FIG. 2B, portions of all 48 flow cells can be seen, though not all structures are shown for every flow cell for clarity. In further detail, a large flow cell applicator (or LFC applicator) is shown that also has a flow path, where fluid is initiated from a source fluid opening 222, which in this instance is a fluid reservoir or well, flows through microfluidic channel 226, across a large flow chamber 224, and then out through microfluidic channel 228, and in some instances into the other source fluid opening or fluid reservoir.

It is noted that the terms “first” and “second” are used herein and throughout the present disclosure. In some instances, the term “third,” “additional” or “other” may be used to describe flow cells or other structures beyond the first and second arrangements identified. These terms are meant to be relative to one another only in the context in which they are mentioned, and further, do not infer any order of use that any one of these terms should be associated exclusively with a specific component. For example, a first flow cell could be referred to as a second flow cell or vice versa. In some instances, the “first” flow cell may be referred to as simply a “flow cell,” as the term “first” is simply used for clarity when describing the flow cell applicator relative to a second (or third, or fourth, etc.) flow cell. Thus, these may be described as a flow cell and a second flow cell in some instances, which refers to the same two structures unless the context dictates otherwise. As another example, if a first flow cell applies a first group of substance spots, and then applies a second group of substance spots, a second flow cell can apply a third group of substance spots (from a microfluidic flow cell array) or a single spot from a large flow cell (LFC) applicator, and so forth.

It should also be noted that a wide variety of other examples are possible. For example, microfluidic flow cell arrays can include multiple flow cells with corresponding arrays of flow chambers, e.g., 4×24, 8×12, 6×8, 6×16, 8×24, and other arrangements. The number of flow cells with corresponding flow chambers can be, for example, up to 48, 96, 192, 384, 768, or up to other numbers of flow cells with associated flow chambers. For example, in addition to the first and second flow cells, there may from 3 to 768 flow cells, from 4 to 192 flow cells, or from 8 to 96 flow cells, for example.

“Microfluidic channels” also can be referred to as channels, conduits, canals, micro-canals, microtubules, tubules and/or tubes, where the terms are used to describe a fluid pathway. However, the microfluidic channels, or other similar nomenclature refer to the microchannels that are defined by the fluid directing bodies described herein, which may be formed by three-dimensional printing. Furthermore, the microfluidic channels may be formed on the micro-scale, providing microchannels or microtubules (of any cross-sectional shape) which are used to guide the substance(s) to and from a deposition surface via their independently fluidly coupled flow chamber, often providing a fluid flow that produces a high surface concentration of a substance at a specific region on a deposition surface. Each deposition region can be individually addressed with its own flow cell, a microfluidic flow cell array may be arranged such that a large number of deposition regions may be addressed in parallel.

When referring to the “cross-sectional” shape, size, dimension, area, etc., of a microfluidic channel(s), it is understood that the term “cross-sectional” in this context refers to the plane of the microfluidic channel that is perpendicular to the direction of fluid flow.

Returning now to FIGS. 2A, the flow cell applicator system 200 can utilize any of a number of mechanical, electrical, and fluidic assembly parts, referred to collectively as a fluid applicator assembly 295, to move the various flow cell applicators relative to a deposition surface 290 and flow fluid through the individual flow cells of the microfluidic flow cell array(s) or other applicators. For example, individual z-axis positioners 250A, 250B can be adapted to alternatively position and seal the microfluidic flow cell array 110 and the large flow cell applicator 220 on the deposition surface, which in this instance can include an assay surface of a sensor chip positioned on a solid optical material 280, e.g., optical prism. The system may or may not include the large flow cell applicator or the second microfluidic flow cell array may be used instead of the large flow cell applicator, for example. The assay surface may or may not include a supplemental coating but can typically include ligands attached to a surface thereof. As a note, the ligands can be pre-applied prior to running the assay, or the ligands can be immobilized (attached, adsorbed, etc.) on the surface by flowing the ligands through a grouping, e.g., array, of flow cells of the flow cell applicator system. In the particular embodiment shown, the positioning assembly comprises a z-axis positioner or z-axis actuator (moving the flow cell toward and away from the sensor substrate). In further detail, the positioning assembly can further include a switching mechanism 252 to switch between multiple flow cell applicators, which in this example is illustrated as a linear track, but could be a robotic arm or some other mechanism that can be used to switch back and forth between multiple flow cell operational subassemblies, which in this example include the microfluidic flow cell array and the large flow cell applicator. Thus, the individual z-axis positioners can position these structures, and more particularly the contact deposition seals 213 and 223, respectively, over the deposition surface of the sensor and then lower them (z-axis lowering) to seal the flow chambers 214 and 224, respectively, against the deposition surface. This can be done at different points in time for overprinting, for example. It is noted that the z-axis positioners can be adjusted along x- and y-axes with coarse and fine adjustment, e.g., to position the flow cell(s) over the deposition surface, for example. On the other hand, the track can be used to switch between the microfluidic flow cell array and the large flow cell applicator, in some examples. Other mechanical systems can be used for switching as well, other than a track, such as mechanical arms, rollers, or other systems. The combination of the z-axis positioner(s) and the flow cell applicator switching mechanism, e.g., track, mechanical arm, rollers, sliders, etc., can be referred to generally as the “positioning assembly.” Thus, for clarity, the positioning assembly refers to the assembly of z-axis positioners and switching mechanism used to switch between the microfluidic flow cell array and the large flow cell applicator (or a second microfluidic flow cell array). Z-axis positioners can be adjusted laterally along the x- and/or y-axis for alignment adjustment, etc.

Optical or other types of positioning sensors 254A, 2548 can help the z-axis positioners position the microfluidic flow cell array and/or the large flow cell applicator, and force sensors 256A, 256B can help the z-axis positioner seal the respective contact deposition seals against the deposition surface. Though a track system (x-axis and/or y-axis switching) and multiple vertical z-axis positioners (z-axis substrate application) are shown by way of example, the systems described herein can include other positioning assemblies adapted to alternatively position and seal the respective contact deposition seals. In further detail, in some embodiments, the positioning assembly can be automated. Using such an automated system, researchers can carry out high-throughput experiments with greatly reduced labor time. Alternatively, or additionally, there can be x-axis and y-axis adjustments on the individual z-axis positioners for adjustment and alignment of the microfluidic flow cell array and/or the large flow cell applicator with the deposition surface.

The z-axis positioner can include controlled motors and/or sensors, e.g., robotically-controlled, computer-controlled, software-controlled, etc., to position and seal the contact deposition seal to the deposition surface. For example, the positioning assembly can include positioning sensors, e.g., optical positioning sensors, force sensors, and other sensors to monitor the location of the positioning assembly in 3D space. In some examples, one or more force sensors can be associated with the microfluidic flow cell array and/or the large flow cell applicator or with the deposition surface to measure the force applied by the microfluidic flow cell array and/or the large flow cell applicator to the deposition surface. A specific predetermined magnitude of force can be associated with a sufficiently fluid-tight seal of the individual flow cell orifices against the deposition surface. The positioning assembly can be configured to lower the microfluidic flow cell array and/or the large flow cell applicator onto the deposition surface and stop lowering when the predetermined force is reached. In another example, the positioning assembly can have a “hard setup,” in which the components of the system are assembled with sufficient tolerance that lowering the microfluidic flow cell array and/or the large flow cell applicator by a predetermined amount forms a fluid-tight seal between the flow cell application interface and the deposition surface without the need of a force sensor.

The positioning assembly can include one or more motors to position the microfluidic flow cell array and/or the large flow cell applicator relative to the deposition surface. In some examples, the positioning assembly can move the microfluidic flow cell array and/or the large flow cell applicator while the deposition surface remains still. In other examples, the positioning assembly can move the deposition surface while the microfluidic flow cell array and/or the large flow cell applicator remain still. In still further examples, the positioning assembly can move both the microfluidic flow cell array and the large flow cell applicator and the deposition surface.

The positioning assembly can include any arrangement of motors or other actuators for alternatively sealing the flow chamber within the contact deposition seal against the deposition surface. For example, the positioning assembly can include robotic arms that can raise and lower, rotate, swing, or otherwise move the microfluidic flow cell array and/or the large flow cell applicator, or the deposition surface, e.g., sensor, can be moved, or both. In some examples, the flow chamber within the contact deposition seal can be maintained in a common plane throughout the process of positioning and sealing the contact deposition seal to the deposition surface. In some examples, the microfluidic flow cell array and/or the large flow cell applicator can be movable along a linear track. The microfluidic flow cell array and/or the large flow cell applicator can move linearly above the deposition surface and then lowered onto the deposition surface. Controlled stepper motors, e.g., robotically-controlled, computer-controlled, software-controlled, etc., can be used to move the flow cell applicators predetermined distances. The microfluidic flow cell array and/or the large flow cell applicator can both be attached to translation structures that can move as a unit, or separately, in the linear direction along the linear track and vertically to contact the deposition surface. Thus, both flow cell applicators can be switched laterally, e.g., x-axis translation, using a switching mechanism without requiring a separate x-axis translation mechanism for each flow cell applicator.

A force sensor and a positioning sensor may also be associated with each flow cell applicator. The positioning sensors aid in positioning the flow cell applicators (and flow cells thereon) over the deposition surface, and the force sensors aid in creating a sufficient seal with the deposition surface. In another example, the microfluidic flow cell array and/or the large flow cell applicator can be in a fixed position, and the assay surface (e.g., test surface of a sensor chip of SPR sensing system) can be moved relative to the flow cell applicators. In still other examples, both the flow cell applicators and the assay surface can be movable. In this embodiment, the deposition surface moves to form a seal with the contact deposition seal. A force sensor and positioning sensor associated with the deposition surface can aid in positioning and sealing the deposition surface with the contact deposition seal, so that the flow chamber becomes enclosed therein.

The positioning assembly can also include any other arrangement of actuators, motors, sensors, and other equipment that is sufficient to alternatively position and seal the contact deposition seal to the deposition surface. Therefore, the positioning assembly is not limited to the specific embodiments described above.

The position of the flow cell applicator(s) may thus be translated by stepper motors, servos, or any other similar device such that it may print multiple arrays of samples on to the assay surface of the target. A group of substance spots for sensor chip deposition can include 2 or more spots, for example, and may be arranged in any number of rows and columns or other array arrangement. When a grouping of flow cells, e.g., array of flow cells, of the flow cell applicator may be finished printing, the flow cell applicator may translate and begin to print another array directly next to the previously applied array or intercalated with the previously applied array. A new array may be applied iteratively until a desired number of spots or density is achieved on the assay surface of the sensor chip. In one embodiment, the flow cell applicator may be translated to a new position to print on a cleaning slide with a cleaning solution used to clean a flow cell application interface before starting or continuing to print. In another example, the flow cell applicator may be translated to another location to print on multiple slides, or to print interstitially relative to other previously deposited spots (or in preparation for future spot positions that may be reserved for a future assay).

In some examples, a flow cell or a grouping (or array) of flow cells of a microfluidic flow cell array can be primed with a carrier solution. When printing has been completed, the applicator assembly translates (vertically) away from the assay surface of the target. The microfluidic flow cell array can be removed from the assay surface of the sensor chip, and the large flow cell applicator can be translated in position to be directly above the face or facial surface of the optical prism (with the sensor chip applied thereto or deposited thereon). The large flow cell applicator assembly can then translate vertically downward to dock on to the top face of the optical prism (or metal layer). A gasket(s) or orifice(s) located about the flow cells at the flow cell application interface can be used to seal the individual flow chambers against a face of the solid optical material (prism) or a sensor chip applied to or placed on the optical prism face. In some instances, the contact deposition seal (of any of the arrays or applicators) can be of a material where no separate gasket is needed. The sealed area between the flow cells and the sensor chip, e.g., a thin metal layer in some instances associated with an optical prism, forms an enclosed chamber, which was previously an open chamber prior to docking against the sensor chip.

The actuators, sensors, and other components of the positioning assembly can be controlled by a processing unit. The processing unit can be incorporated into the system, such as an integrated computer. Alternatively, the processing unit can be an external unit, such as a personal computer. The positioning assembly can transmit data to the processing unit and receive instructions from the processing unit through a wired or wireless connection. The processing unit can also control other components of the system, such as pumps and/or valves for flowing fluid through the microfluidic flow cell array and/or large flow cell applicator, pumps and/or valves for flowing air or gas for liquid fluidic control, devices for refilling fluid reservoirs, devices for changing deposition substrates, biosensors, and so on.

Generally, a system for depositing substances onto a deposition surface in accordance with the present disclosure can include at least one microfluidic flow cell array. This can allow the microfluidic flow cell array to deposit multiple spots of different substances onto the deposition surface simultaneously. The system can also include a second microfluidic flow cell array and/or large flow cell applicator. In cases where there is a second microfluidic flow cell array, the second array can include multiple flow cells, similar to the first flow cell applicator, e.g., a second microfluidic flow cell array. The flow cell applicator system can further include a positioning assembly adapted to alternatively position and seal the contact deposition seal(s) defining the flow chambers on the deposition surface.

In further detail, however, the positioning assembly shown and described in FIG. 2A can also be fine-tuned to position and then reposition the same microfluidic flow cell array 110 at a location that is offset relative to previously deposited spots. In FIG. 2B, for example, four different arrays of spots are shown as white spots which are labeled generally as spots “a.” Other spot locations can then be applied therewith using the microfluidic flow cell array or another similar flow cell applicator also having multiple flow cells. For example, a second set of spots can be applied interstitially in an overlapping manner relative to spots “a,” which are shown as spots “b” in FIG. 2B. Alternatively, the second set of spots can be interstitially applied in a non-overlapping manner, such as shown with respect to spots referenced as “c.” Then, as shown in FIG. 2B, for example, a large flow cell applicator can be used to deposit larger overlapping deposition spots denoted in FIG. 2B as spot “x.” In FIG. 2A, it is noted that only type “a” spots and type “x” spots are shown, but as can be seen in FIG. 2B, various combinations of spots can be applied, depending on the nature of the experiments to be conducted on the assay surface.

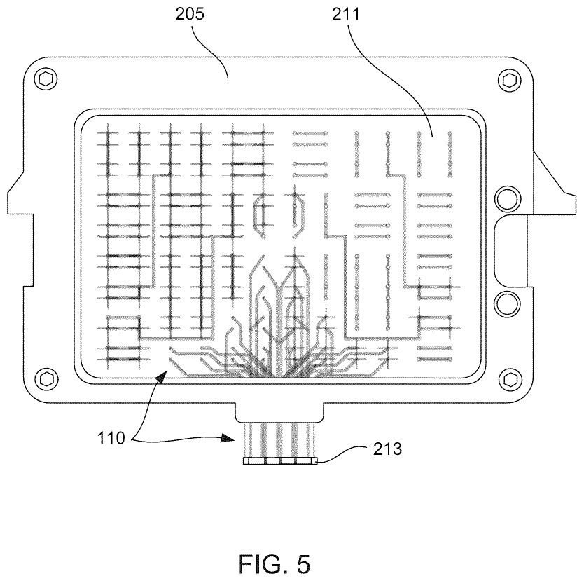

In further detail, the flow cell applicator systems 200 of the present disclosure can in some instances include a cartridge (not shown, but shown in FIG. 5) configured to carry the microfluidic flow cell array 110 and to interface with the fluid applicator assembly 295. For example, the microfluidic flow cell array can include alignment features corresponding with a configuration of the cartridge so that the microfluidic flow cell array can be conveniently aligned and joined therewith. In some examples, the microfluidic flow cell array and the cartridge can both be three-dimensionally printed at least in part. In further detail, the microfluidic flow cell array can include a self-destructing component so that it can only be used one time or a specific number of times or for a specific time period before the microfluidic flow cell array is rendered inoperable. To illustrate, the microfluidic flow cell array may be prepared to include multiple materials and the first material may be shelf-stable, whereas the second material self-destructs after a pre-determined number of uses or a pre-determined amount of time rendering the microfluidic flow cell array inoperable.

Referring now to FIG. 3, an example three-dimensionally printed microfluidic flow cell array 110 is shown in three views, including a top plan view (A), an end view (B), and a partial perspective view (C). Dashed arrows are shown to illustrate the relationship between the three different views. The various views are provided as schematic illustrations and are not intended to be to scale or show every feature of this example that may be present. Dotted lines are used to show various example pairs of microfluidic channels, though not all pairs of microfluidic channels nor their completion to their respective source fluid openings are shown in each instance to avoid obscuring the clarity of the drawing.

With respect to this microfluidic flow cell array 110, as shown at (A), there are a plurality of flow cells 210A, 210B, etc., defined by two structures, which may be two portions of the same structure or may be two structures joined together, namely a fluid directing body 211 and a contact deposition seal 213. The fluid directing body includes multiple layers 231 of three-dimensionally printed material, as shown schematically at (B). The fluid directing body defines a first pair of microfluidic channels 215, including microfluidic channels 216 and 218. The microfluidic channels individually transect a portion of the multiple layers and also redirect fluid flow when within the fluid directing body. This can be seen at (B) and (C) where the individual microfluidic channels pass perpendicularly through the layers of three-dimensionally printed material before traversing in alignment (parallel) with the plane of the printed material layers. Notably, the first pair of microfluidic channels are shown at different locations in (A) and (B) compared to (C), illustrating that the first pair of microfluidic flow channels and other structures of a “first” flow cell can be at any location. In addition to a first flow cell 210A, FIG. 3 also shows a second flow cell 210B. In this example, there may also be a 3^{rd} to 96^{th} flow cell that includes each of the components of the first and second flow cells. The second flow cell (and many or all of the other flow cells) can likewise include a (second) pair of microfluidic channels that individually transect a portion of the multiple layers and also redirect fluid flow when within the fluid directing body. As mentioned, the microfluidic flow cell array also includes a contact deposition seal 213 adapted to contact a deposition surface (not shown in this FIG.) and deliver fluid thereto. The contact deposition seal can define a first flow chamber 214 that is fluidly coupled to adjacent terminating ends (shown at 217 in FIG. 4) of the first pair of microfluidic channels forming the first flow cell. There can also be a second flow chamber that is fluidly coupled to adjacent terminating ends of the second pair of microfluidic channels forming a second flow cell. Notably, at the other end of the pair of microfluidic channels are a pair of source fluid openings 212 or ports (distal with respect to the contact deposition seal). The source fluid openings are simply openings to the pair of microfluidic channels, but could include a fluidic interface 221 for user or machine interaction with the source fluid openings of the microfluidic channels, e.g., integrated fluid wells, luer connectors, removable plugs, pipette adaptors (to accept pipette tips), syringe adaptors (to accept syringe tips), needle adaptors, fluidic through-holes, nanoport assemblies, fluidic seals or valves coupled to fluid vessels, bulk fluidic ports, air control ports, fluid sample ports, waste ports, etc. In this example, the source fluid openings are shown as being associated with a pair of integrated gaskets, e.g., O-rings or other structure that surround the source fluid openings sized to provide a sealing force for the fluid within the microfluidic channels.

As can be seen particularly at (B), there are multiple three-dimensionally printed layers printed. As a note, the multiple layers shown at (B) are for illustrative purposes only, as there would likely be many more layers than that which can be practically shown at this scale. In this example, the printing was in the direction of the thickness of the thickness of the microfluidic flow cell array, unlike that shown in FIG. 1A, which would have been printed in a direction of the length or width of the microfluidic flow cell array.

Referring now to FIG. 4, an alternative microfluidic flow cell array 110 is shown which includes a plurality of flow cells. In this example, a first flow cell 210A is shown by way of example, along with 15 additional flow cells for a total of 16 total flow cells in this particular example. Notably, in other examples, there could be as many as 24, 32, 48, 64, 72, 88, 96, 128, or even up to as many as 192 flow cells within a similarly configured structure. The first flow cell again is defined by two structures, which may be two portions of the same structure or two separate structures joined together. The microfluidic flow cell array includes a fluid directing body 211 and a contact deposition seal 213. The fluid directing body includes multiple layers of three-dimensionally printed material, as shown schematically at (A) at 231. Notably, unlike the direction of fabrication shown in FIG. 3, wherein the microfluidic flow cell array is manufactured in a direction of the part thickness, in this instance, the part is manufactured in a direction of the part length. Thus, in this example, the direction of printing would be more like that shown in FIG. 1A which may be prepared using a top-down method as shown, or may be prepared using a bottom-up method, not shown. The multiple layers shown at (A) are for illustrative purposes only, as there would likely be many more layers than that shown.

Again, the fluid directing body 211 defines a first pair of microfluidic channels 215, including microfluidic channels 216 and 218. The microfluidic channels individually transect a portion of the multiple layers and also redirect fluid flow when within the fluid directing body. This can be seen at (A) where the individual microfluidic channels pass perpendicularly through the layers of three-dimensionally printed material. Notably, other flow cells, e.g., a second flow cell and/or a 3^{rd}-16^{th} flow cell, can likewise include a pair of microfluidic channels that individually transect a portion of the multiple layers and also redirect fluid flow when within the fluid directing body.

As mentioned, the microfluidic flow cell array 110 also includes a contact deposition seal 213, shown at (C) and (D), adapted to contact a deposition surface (not shown in this FIG., but shown in FIGS. 2A and 2B) and deliver fluid thereto. The contact deposition seal can define a first flow chamber 214 that is fluidly coupled to adjacent terminating ends 217, shown at (A) and (B) via a pair of deposition seal channels 219, shown at (C) and (D), collectively forming the first flow cell 210A. There can also be a second flow chamber (and/or 3-16 more flow chambers) that is fluidly coupled to adjacent terminating ends of the second pair of microfluidic channels forming a second flow cell (or 3^{rd} to 16^{th} flow cells). At the other end of the pair of microfluidic channels are a pair of source fluid openings 212 (distal with respect to the contact deposition seal). The source fluid openings provide openings to the pair of microfluidic channels, but could include a more elaborate fluid interface 221 for user or machine interaction with the source fluid openings of the microfluidic channels, as previously described. In some examples, there may also be an alignment feature(s) 209 on one or both of the fluid directing body 211 and/or the contact deposition seal.

In the context of the microfluidic flow cell arrays of the present disclosure, including both those shown being printed or after printing in FIGS. 1-4, there are additional details that can be designed into these structures for additional versatility. For example, the microfluidic flow cell array can include a first material and a different second material. In one example, the first material can be three-dimensionally printed and the second material is not three-dimensionally printed. In other examples, the first material may be a polymeric material that is three-dimensionally printed and the second material may be non-polymeric material. In additional detail, a first pair of microfluidic channels may include flow paths along multiple parallel planes within the fluid directing body. In other examples, a first pair of microfluidic channels and a second pair of microfluidic channels can be formed to have the same flow resistance relative to a common fluid.

Referring now to FIG. 5, a microfluidic flow cell array 110 including a fluid directing body 211 and a contact deposition seal 213 is shown inserted within and being carried by a cartridge 205. The cartridge can be suitable for insertion into flow cell applicator system 200, such as that shown by way of example in FIGS. 2A and 2B. Though a cartridge is shown in this example, as the microfluidic flow cell arrays of the present disclosure can be formed using materials of a different stiffness and/or mechanical properties, in some examples, there may be flow cell applicator systems adapted to receive a microfluidic flow cell array without the presence of a cartridge. Furthermore, if a cartridge is needed for insertion into a particular flow cell applicator system, the cartridge can likewise be printed separately, or the cartridge shape can be printed directly on or as part of the operable portion of the microfluidic flow cell array. In other words, the microfluidic flow cell array can be printed to include rigid features so that it can be inserted into a flow cell applicator system that may be otherwise configured to receive a cartridge.

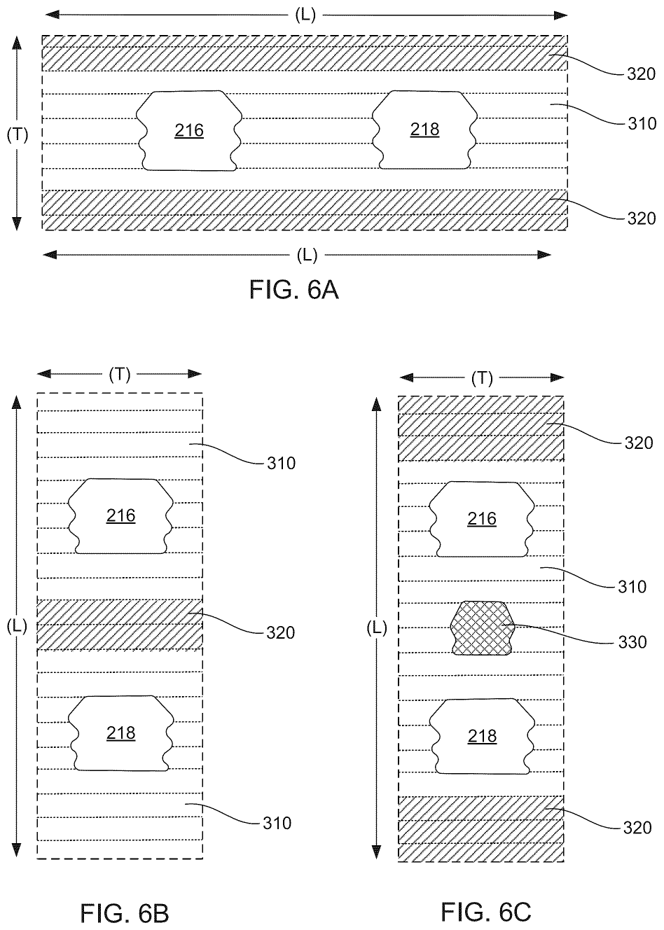

In further detail regarding the manufacture of three-dimensionally printed microfluidic flow cell arrays, schematic small sections of a few fluid directing bodies 211 with individual microfluidic channels 216 and 218 of a pair of microfluidic channels are shown in FIGS. 6A-6C. These examples illustrate how multiple materials may be used within a fluid directing body of a microfluidic flow cell array.

Referring now to FIG. 6A, a partial view of about nine (9) layers is shown in cross-section relative to the direction of fluid flow through two individual microfluidic channels 216 and 218 of a pair of microfluidic channels. Immediately surrounding the individual microfluidic channels is a first material 310. Furthermore, above and below the microfluidic channels defined by the first material in a direction of the part thickness (T), there are multiple layers of a second material 320.

Example first and second materials can independently include silicon, silica, gallium arsenide, glass, ceramic, quartz, neoprene, urethane, polyethylene glycol diacrylate, polytetrafluorethylene, perfluoroalkoxy polymer, fluorinated ethylene propylene polymer, tetrafluoroethylene copolymer, polybutadiene/styrene-butadiene, polyethylene terephthalate, nitrile polymer, polydimethylsiloxane, polylactic acid, acrylonitrile butadiene styrene, polyamide, polyvinyl alcohol, thermoplastic elastomer (e.g., urethane, polyethylene elastomer, etc.), or a combination thereof. In some examples, the first material can be a polymer and the second material can be a metal or other non-polymeric material.

As shown in FIG. 6B, a partial view of about twenty (20) layers is shown in cross-section relative to the direction of fluid flow through two individual microfluidic channels 216 and 218 of a pair of microfluidic channels. Immediately surrounding the individual microfluidic channels is a first material 310. Furthermore, between the microfluidic channels (and the first material that defines the microfluidic channels) in the directions of part length (L), there are multiple layers of a second material 320. As a note, printing in the direction of the length could be similarly reoriented in the direction of the width (W) when the length (L) and width (W) of the part are defined as the X-Y axis and the thickness (T) is defined as the Z axis, for example. Thus, printing by width or length can be interchangeable, as those are typically the largest dimensions relative to the thickness.

As shown in FIG. 6C, a partial view of about twenty (20) layers is shown in cross-section relative to the direction of fluid flow through two individual microfluidic channels 216 and 218 of a pair of microfluidic channels. Immediately surrounding the individual microfluidic channels is a first material 310. Furthermore, in a direction above and below the pair of microfluidic channels and the first material that defines the microfluidic channels in the directions of part length (L) (but not in between), there are multiple layers of a second material 320. Also in this example, between the microfluidic channels (and the first material that defines the microfluidic channels) in the directions of part length (L), there is an auxiliary channel formed of a third material 330, which may be a thermal control channel, e.g., coolant, heated fluid, liquid or solid metal, etc., an electrical interaction channel, e.g., carrying conductive or semi-conductive material, an optical channel, carrying fiber optics or other optical material, or the like. Notably, structures shown in FIGS. 6A and 6B may be prepared by using different materials in a layer-by-layer printing process. However, in this example, the auxiliary channel may be printed by applying a third material using a voxel-by-voxel printing process, where each layer may be prepared with multiple different materials applied thereto, e.g., Polyjet printing. In a Polyjet printing example, the first material 310, the second material 320, and the third material may be different, and the two individual microfluidic channels 216 and 218 may be formed using a support material (not shown), which has been removed in the example shown at FIG. 6C. Notably, the support material may also be printed in this example in a voxel-by-voxel process, as there would be individual layers that would include both the first material and the support material (prior to removal or channel clearing).

In these examples, the individual microfluidic channels 216 and 218 of the fluid directing body 211 are defined laterally (relative to the orientation of material layers) by three individual printed layers of the first material 310, by way of example. However, the microfluidic channels could be defined by the second material or partially defined by the first material and partially defined by the second material. Furthermore, there could be fewer or more than three material layers defining the microfluidic channels. For example, in some embodiments, each of the material layers as applied or printed may have a thickness from about 5 μm to about 250 μm, from about 10 μm to about 200 μm, or from about 15 μm to about 150 μm. For perspective, a microfluidic flow cell array prepared in accordance with examples of the present disclosure may have a thickness (T) in the order of a few millimeters to several centimeters, e.g., from about 2 mm to about 5 cm or from about 5 mm to about 3 cm. Thicknesses outside of these ranges can likewise be used, as these dimensions are provided by way of example. With respect to the length (L) and the width (W), those dimensions are typically larger than the thickness, and can independently range from about 2 cm to about 50 cm, from about 4 cm to about 30 cm, from about 5 cm to about 20 cm, or from about 5 cm to about 10 cm, for example. With more specific reference to the layer thicknesses, compared to the dimensions of the fluid directing body in any orientation, the thicknesses are much less, e.g., typically from about 5 μm to about 250 μm, from about 5 μm to about 200 μm, from about 10 μm to about 150 μm, or from about 15 μm to about 100 μm of layer thickness. Thicknesses outside these ranges can also be utilized, depending on the application. Thus, each of the microfluidic channels shown in this example could independently be formed of from 1 layer to about 40 layers, from about 2 layers to about 30 layers, or from about 3 layers to about 20 layers, for example. In further detail, microfluidic channels can be formed having an average cross-sectional size (perpendicular to the direction of fluid flow) from about 5 μm to about 200 μm, from about 5 μm to about 100 μm, from about 10 μm to about 100 μm, from about 10 μm to about 75 μm, from about 10 μm to about 60 μm, from about 15 μm to about 50 μm, or from about 20 μm to about 50 μm, for example. With three-dimensional printing, it is also noted that the cross-sectional size or shape perpendicular to the direction of fluid flow can be tapered or otherwise have different sizes at different locations along the length of the individual microfluidic channel, or can be different than other microfluidic channels or pairs of microfluidic channels. When printing in the direction of the length (L) or width (W) of the microfluidic flow cell array or the fluid directing body, as an example, the part may be printed with from about 1,000 to about 25,000 layers. When printing in the direction of the thickness (T) of the microfluidic flow cell array or the fluid directing body, as an example, the part may be printed having from about 50 to about 2500 layers, or from about 100 to about 1000 layers, for example.

In additional detail regarding the use of multiple materials in a three-dimensionally printed microfluidic flow cell array, in some examples, the first pair of microfluidic channels can be defined by the first material, and the second material can be shaped as an elongated structure that runs parallel with the first pair of microfluidic channels. In other examples, a second pair of microfluidic channels can likewise be defined by the first material, and the elongated structure can also run parallel with the second pair of microfluidic channels. In other examples, the elongated structure does not define interior surfaces of the first pair of microfluidic channels, but may be positioned within 2 mm or even within 1 mm of an interior of one or both of the first pair of microfluidic channels. In another example, the elongated structure can be sufficiently close to interact with a fluid carried by the first pair of microfluidic channels thermally, electrically, or optically. In still another example, the fluid directing body can include an outer shell and an inner core. In this example, at least a portion of the outer shell may include the second material and the inner core defining a majority of the first pair of microfluidic channels and the second pair of microfluidic channels can include the first material. In still other examples, at least 60 wt % of the fluid directing body can be of the first material, and the second material can be positioned between the individual microfluidic channels of the first pair of microfluidic channels as well as the individual microfluidic channels of the second pair of microfluidic channels. In still other examples, the first material and the second material can be arranged in a fluid directing body such that in operation using fluids of the same initial temperature, temperature variation at the first pair of microfluidic channels may be less than 0.1° C. compared to the second pair of microfluidic channels.

In further detail regarding auxiliary channels that may be included within the body of the microfluidic flow cell array (e.g., the fluid directing body, the contact deposition seal, or both), there can be any of a number of types of auxiliary channels and/or functions. In one example, a first auxiliary channel (or multiple auxiliary channels) can run in parallel with at least a portion of the first pair of microfluidic channels at a location to interact with fluid carried by the first pair of microfluidic channels. The auxiliary channel(s) may be filled, for example, with a gas, a liquid, a liquid or solid metal, a conductor, a semi-conductor, an insulator, an electronics component, an optical component, a chemical reagent, or a combination thereof. The auxiliary channel(s) may act as a thermal control channel containing or to contain heated or cooled fluid. In other examples, the fluid directing body may include a first material having a higher thermal conductivity and heat capacity compared to a second material, and furthermore, the first material can be positioned between individual microfluidic channels of the first pair of microfluidic channels and a thermal control channel and the second material can be positioned to thermally insulate the first pair of microfluidic channels and the thermal control channel from the second pair of microfluidic channels. In other examples, the thermal control channel can run between individual microfluidic channels of the first pair of microfluidic flow channels. In further detail, the thermal control channel can run in parallel with individual microfluidic channels of the first pair of microfluidic flow channels, but not in between the individual microfluidic channels. In still other examples, the thermal control channel can include an electrical medium selected from conductive liquid, a liquid metal, or metal that was flowed therein and allowed to solidify, eutectic alloys, polymer-particle composites, conductive polymers, etc. These materials can likewise be used in some instances for electrical conductivity, for example. In the context of the thermal control channel, these materials can be adapted to generate heat when electrical potential is applied to the electrical medium. In addition to the first auxiliary channel, as mentioned there can be others as well. For example, a second auxiliary channel can run in parallel with at least a portion of the first pair of microfluidic channels at a location to interact with fluid carried by the first pair of microfluidic channels. In this and other examples, the second auxiliary channel can be filled with a gas, a liquid, a liquid or solid metal, a conductor, a semi-conductor, an insulator, an electronics component, an optical component, a chemical reagent, or a combination thereof.

With respect to the microfluidic flow cell array, including one or both of the fluid directing bodies and/or contact depositions seals thereof, there may be certain structural differences and/or benefits to forming these structures by a three-dimensional printing process. For example, with very thin individual build material layers, relatively high resolution microfluidic channels can be formed that may not require mechanical boring or cutting to achieve relative smoothness within the microfluidic channels. With such smoothness or high resolution, low defect topography can be achieved by good 3D modeling and proper equipment and material choice, including in areas such as the various lumens, source fluid openings, fluidic interfaces associated with the source fluid openings, terminating ends of the pairs of microfluidic channels, flow chambers, deposition seal channels, etc. In some examples, at locations where there are multiple materials at a layer-to-layer interface, there may be material diffusion that occurs, creating a thin interface layer where both materials are blended together as a composite layer, providing good layer adhesion between the two regions of bulk material layer application without the presence of an adhesive of a separation heat fusion step. Furthermore, with three-dimensional printing, there may be increased fabrication speed benefits by applying some layers at a greater thickness than others. With three-dimensional printing, there may also be structural features that can be designed into the 3D model that are used to print the part that would otherwise be difficult, impractical, or potentially impossible to fabricate using current available technology.

Various structural arrangements of the microfluidic flow cell arrays of the present disclosure may be customized as well, due to the flexibility of three-dimensional printing. Customized structural arrangements that may benefit from three-dimensional printing include the following: source fluid openings or pairs of source fluid openings at a common surface or at different surfaces; flow chambers along a common surface of different surfaces; cross-sectional areas of a first pair of microfluidic channels being different than a second pair of microfluidic channels; non-conventional or variable flow cell dimension, such as changing cross-sectional shapes, cross-sectional areas, cross-sectional height, cross-sectional width, etc., along the length of a microfluidic channel, including microfluidic channels that change more than once along the length thereof; flexibility of cross-sectional shapes, e.g., round, oval, elliptical, trapezoidal, or triangular, rectangular, square, etc.; inclusion of flow modification structures that promote mixing, circulation, diffusion of fluids, flow velocity, flow uniformity, and/or flow efficiency, e.g., bumps, ridges, recesses, 3D patterns, angled surfaces, chevron shapes, etc.; alignment features for joining structures, e.g., pins, tabs, bumps, cutouts, etc. such as for joining fluid directing body with contact deposition seal, docking contact deposition seal with deposition surface, inserting fluid injectors into source fluid openings, joining microfluidic flow cell array with cartridge assembly of printer/spotter apparatus or system; ability to print indicia on microfluidic flow cell array, e.g., logos, security, instructions, self-destruct features, etc.; ability to form one-off custom contact deposition seal; implementation of modular/interchangeable contact deposition seals; for example.

When using two different build materials in forming a microfluidic flow cell array, or one or both of the fluid directing bodies and/or contact deposition seals to subsequently join together, several properties can be leveraged as they relate to the multiple materials chosen for use. For example, the two materials may have a difference in softness or stiffness, e.g., softer contact deposition seal or fluidic interfaces relative to material defining microfluidic channels; heat capacity and/or thermal conductivity, e.g., thermally interacting with individual microfluidic channels or pairs of microfluidic channels or larger groups of microfluidic channels; optical absorbance and/or optical refractive index, e.g., waveguides, channeling light, optical sensing, etc.; electrical conductivity or resistivity, e.g., traces or wires, liquid metals, resistive heaters, actuators, sensors, components to promote electrolytic reactions or interactions with charged or dielectric particles or form electric fields, etc.; chemical interaction, e.g., sacrificial coatings within microfluidic channels, pre-loaded reagents, etc.

In more specific detail, when there are multiple materials used, the first material can have higher thermal conductivity or heat capacity than the second material. For example, the first material can have a thermal conductivity from 0.1 W/m-K to 0.25 W/m-K and the second material can have a lower thermal conductivity ranging from 0.25 W/m-K to 0.5 W/m-K, In another example, the first material can have a heat capacity from 1.5 J/g-C to 2.5 J/g-C and the second material can have a lower heat capacity from 0.5 J/g-C to 1.2 J/g-C.

In examples related to the use of multiple materials with different stiffness, the first material may have a higher stiffness than the second material. For example, the first material may have an elasticity (or stiffness) from 0.1 GPa to 5 GPa and the second material may have an elasticity (or stiffness) from 0.1 MPa to 50 MPa.

In examples related to the use of multiple materials with different optical absorbance or optical refractive index, the first material may have a higher optical absorbance or optical refractive index than the second material. For example, the first material may have an optical absorbance of 0.1 or greater in a visible or near IR wavelength and the second material may have an optical absorbance of less than 0.1 at a visible or near IR wavelength. In other examples, the first material may have an optical refractive index from 1.5 to 1.9 and the second material may have an optical refractive index from 1.3 to 1.5. In still other examples, the first material and the second material can be positioned relative to one another to form an optical waveguide within the fluid directing body, the contact deposition seal, or both. For example, the optical waveguide can be positioned to make a measurement within the fluid directing body, within the contact deposition seal, at a deposition surface (before, after, or in contact with the deposition seal), or a combination thereof. The measurement to be made may relate to any type of measurement, including a temperature measurement, an optical measurement, a chemical measurement, a mechanical measurement, a pressure measurement, etc. The optical waveguide, for example, can be adapted to deliver light to the first pair of microfluidic channels, the first flow chamber, a deposition surface (before, after, or in contact with the deposition seal), or a combination thereof. In another example, the optical waveguide can be adapted to deliver light to generate an optical change in the microfluidic flow cell array, a deposition surface (before, after, or in contact with the deposition seal), or a combination thereof.

In examples related to the use of multiple materials with different electrical conductivities, the first material may have a higher electrical conductivity than the second material. For example, the first material may have an electrical conductivity from 10⁻⁷ S/M to 10⁸ S/m and the second material may have an electrical conductivity from 10⁻¹⁶ S/m to 10⁻¹² S/m. In examples with multiple electrical conductivities, the second material may define a first pair of microfluidic channels, and the first material may be positioned at or adjacent to the contact deposition seal. In other examples, the first material may be in the form of an electrical element selected from a wire, a heater, an actuator, or a sensing element. For example, the first material may be in the form of a sensing element capable of measuring the conductivity of a fluid within the first flow cell. In other examples, the first material may be in the form of an electrical element capable of generating an electric field across a fluid within the first flow cell. In other examples, the electric field may enable retention of charged or dielectric particles within the flow cell. In still other examples, the first material may be in the form of an electrical element capable of causing an electrolytic reaction within the first flow cell. For example, the electrolytic reaction may be capable of forming a bubble within the first flow cell.

In examples related to the use of multiple materials with different chemical resistance, the first material may have a higher chemical resistance than the second material. For example, the first material may have a higher chemical resistance to at least one solvent selected from isopropyl alcohol, DMSO, or acetone when compared to the second material.

In further detail, the microfluidic flow cell arrays of the present disclosure can be adapted to be rendered inoperable after a certain number of uses, after a certain period of time, or after another parameter established by the user (to ensure good operability) or the manufacturer (to ensure operating under licensing agreement), for example. In one implementation of this, the first material can be shelf stable, and the second material can self-destruct after a pre-determined number of uses rendering the microfluidic flow cell array inoperable. In another example, the first material can be shelf stable, and the second material can self-destruct after a pre-determined amount of time rendering the microfluidic flow cell array inoperable. In another example, the fluid directing body or the contact deposition seal can be adapted to be punctured or otherwise rendered inoperable by a flow cell applicator system or device carrying the microfluidic flow cell array. In another example, the fluid directing body or the contact deposition seal can be adapted to communicate with a flow cell applicator system or device after the microfluidic flow cell array is spent, rendering the microfluidic flow cell array inoperable either by software instructions or the flow cell applicator system or device destroying the microfluidic flow cell array. For example, the microfluidic flow cell array can be determined to be spent based on a certain number of uses or a certain amount of time, or the number of uses or amount of time allowed can be determined by indicia located on the microfluidic flow cell array or associated chip.

For clarity, a “microfluidic flow cell array” or “MFCA” can be a monolithic body of a single or multiple materials three-dimensionally printed in layers, or can include an assembly of multiple parts joined together. The MFCA is adapted for directing fluid(s) to a deposition surface by sealing a flow chamber thereof to the deposition surface and flowing the fluid(s) across the deposition surface. The microfluidic flow cell array is not the printer or spotter per se, but rather a microfluidic interface between a printer/spotter apparatus or system and the deposition surface. The microfluidic flow cell array may be disposable and replaceable within a printer/spotter apparatus. Thus, a printer/spotter may utilize a single or multiple microfluidic flow cell array(s), or may utilize other flow cell applicators in addition to the microfluidic flow cell array(s). The microfluidic flow cell array may arrange the various elements of multiple flow cells in any of a number of orientations, with flow chambers positioned in any of a number of patterns. Thus, the term “array” does not infer order or spatial arrangement, other than to indicate that there are multiple flow cells present. The flow chambers, for example, may be positioned on one or multiple surfaces in any pattern or random configuration. In other words, the term “array” does not necessarily require rows and columns, but in some examples, may include rows and columns, patterns of shape, offset patterns, random patterns, etc. There is no particular size limitation of the spot size applied by the microfluidic flow cell array, provided the array is adapted to apply multiple spots.

A “large flow cell applicator,” “LFC,” or “single large flow cell applicator” is similar to a microfluidic flow cell array, but in accordance with the present disclosure, an LFC has a single flow cell (not multiple flow cells) and is often used to overprint (or underprint) on a deposition surface at the same location as multiple spots applied by a microfluidic flow cell array. The term “large” simply indicates that the flow chamber size of the flow cell is large enough to apply fluid at the same location as a plurality of spots applied using a microfluidic flow cell array.

The term “deposition surface” refers to any surface or combination of surfaces to which a contact deposition seal of a microfluidic flow cell array is pressed to receive fluid or substance deposition via a flow chamber of the contact deposition seal. The deposition surface may be an inert substrate that does not interact with the fluid or substance, or the deposition surface may interact with the fluid or substance. In some instances, the deposition surface may be a coating on a substrate, or may be provided solely by a single substrate, for example. The deposition surface may be an assay surface in some examples.

The term “assay surface” refers to a surface of a sensor chip, e.g., thin metal film, metal coupon, grating, etc., of a sensing substrate, e.g., sensor chip with or without a solid optical material, where material may be spotted with a printing system, and where chemical interactions can occur. In the context of SPR, the assay surface can be one side of a sensor chip that may include supplemental coatings, pre-applied ligands, etc., and can be spotted or applied for generating substance interactions. Thus, the assay surface may be transparent, translucent, thermally conductive, electrically conductive, insulated, etc. Sensors associated with the assay surface may be mechanical, optical, physical, chemical, electrical, or like, and can detect mechanical properties, e.g., pressure or flow, temperature, optical properties, e.g., SPR, electrical properties, e.g., capacitance or conductivity, chemical properties, such as pH or colorimetric analysis, etc.

The deposition surface may be a surface of a “sensing substrate, which can be used for optical or non-optical sensing. For example, a sensing substrate can include i) a solid optical material, e.g., optical prism or structure of some other shape used for shaping an optical beam; ii) a sensor chip, e.g., material layer(s) such as a thin (metal) film, (metal) coupon, or grating structure, etc.; iii) a solid optical material in combination with a separable sensor chip (metal, grating, etc.) where the sensor chip is removable or can be placed on or attached to the solid optical material, etc.; iv) a solid optical material with a sensor chip in the form of a film applied or adhered thereto; v) an array of electrochemical sensors on a silicon substrate of similar surface; vi) an array of thermal sensors on a mechanical substrate; vii) etc. The sensing substrate, if included with a sensor chip (as a modular component or as a film) can have an assay surface on one side and an optical interface surface on the other side, e.g., SPR; or the sensor chip can include an assay surface on one side with the optical interface surface being on the same side. In further detail, the “sensing substrate” can further be defined to include any substrate on which material can be deposited at the deposition surface, and in some instances an assay can be carried out and/or the optical sensing of the deposited material (directly or indirectly) can occur. Examples of sensing substrates include i) an opaque substrate (e.g., paper, plastic, silicon, ceramic, metal, etc.); and/or ii) transparent or translucent substrates, such as may be used for beam shaping, filtration, etc., e.g., optical prism for shaping optical beams. In some examples, it is noted that the microfluidic flow cell array may be integrated with the sensing surface.

The term “solid optical material” refers to any solid shape of optical material where light can enter and interact with a deposited sample, directly or indirectly (SPR), e.g., optical prism for beam shaping, or some other beam shaping configuration. In many instances, an optical prism will be described with some specificity. It is noted, however, that the prism can be any shape that is suitable for shaping light energy for use with the sensing substrate in accordance with examples of the present disclosure.

The term “chip” or “sensor chip” refers to a data collection component used for measuring surface interactions. A sensor chip may include a thin layer(s) of material (such as a metal film or a film of another material, for example) applied to a solid optical material, a grating structure, or a coupon of material (such as metal or other material, for example). The sensor chip does not include the solid optical material but may be applied to the solid optical material. The sensor chip can include multiple surfaces, including an assay surface where chemical or other interactions can occur, and an optical surface where optics can sense the interactions. Specifically, in an SPR configuration and some other similar types of sensor configurations, the assay surface can be positioned opposite the optical interface surface. In other configurations, however, the assay surface and the optical interface surface can be the same surface, or there can be a different spatial relationship between these two surfaces. Regardless, the “sensor chip” may be preloaded with a supplemental coating(s), ligand(s), or any other material(s) that may be useful for evaluating substance interactions. The sensor chip may be referred to as a “thin metal layer” or “thin layer” in some more specific examples, or as a “metal coupon” or “coupon” in other specific examples. It is noted that in some examples, the sensor chip may be affixed or attached to the solid optical material (as a film or adhered thereto) or can be set in place in contact with a facial surface of the solid optical material (as a sensing substrate that is modular), for example. For clarity, in another context, the term “chip” can alternatively refer to a component that uses memory for storing data, and thus can be referred to more specifically as a “data chip,” “memory chip,” or the like.

The term “SPR sensor” or “SPR sensing system” refers to surface plasmon resonance sensing systems, including a light energy source, a sensor chip with an assay surface and an optical interface surface (and in some cases a solid optical material as shown in FIG. 2, for example), and a detector to receive reflected light from the optical interface surface. The term “sensor in this context does not imply a single structure but is a system of structures that work collectively to generate SPR data and images, for example. The SPR sensor includes substructures that are sometimes referred to as “sensors,” such as the “optical interface surface” of the sensor chip or the detector or camera (imager) that receives reflected light from the optical interface surface.

The term “optical interface surface” refers to a surface of a sensor chip, e.g., thin metal film, metal coupon, grating, etc., that interacts optically with other components of a more general “sensor” system. The optical interface surface may be the same surface as the assay surface, but in the case of SPR, the optical interface surface is the opposing surface relative to the assay surface. In other words, specifically with SPR, optical sensing can occur at a detector after reflection(s) occurs from the optical interface surface, and thus, the optical interface surface can sometimes be referred to as an SPR “reflecting surface.” For clarity, with SPR, the optical interface surface is not the same surface where chemical or other substance interactions are occurring, e.g., occurring at the assay surface. However, it is noted that in other systems other than SPR, the optical interface surface and the assay surface may be the same surface.

The term “sample” can be used to refer to fluidic compositions that include particles, molecules, compounds, or other species of materials that are used to conduct experiments on the assay surface, which are sensed using the optical interface surface of a (sensor) chip. The sample can be a fluid, substance, analyte, particle, probe, or immobilized ligand, etc., depending on the context. Sometimes “sample” is used with another term for further context, such as “sample substance,” “sample ligand,” “sample spot(s),” etc. Samples may also include other material(s) or carrier fluids, such as liquid vehicle, buffer solution, etc.

The term “spot” refers to a sample applied at a discrete location on a deposition surface, such as an assay surface of a sensor chip. The sample can be applied as a fluid sample that dries, or can remain undried. In some instances, a second sample can be applied to the same location in an overlapping manner. Sometimes spots are applied by a microfluidic flow cell array, and then other spots are applied adjacently or overlaid (partially or fully) with other “spots” of typically a different sample (different substance, different substance concentration in a fluid sample, different spot size, etc.).

### EXAMPLES

### Example 1—Stereolithography Printing (SLP) of Fluid Directing Bodies

A microfluidic flow cell array similar to that shown in FIG. 4 was printed using stereolithography with a top-down printing orientation similar to the process shown in FIG. 1A, i.e. the microfluidic flow cell array being adhered to a lower surface of the build platform as the part is built in a downward direction. The process of stereolithography typically uses a masked laser light source to produce a single layer of a cured material from a liquid photocurable resin that the part is partially or fully submersed in. Thus, at the build end of the part, a laser light can be directed (typically using a mirror) to the areas of a layer that is to be photocured at a depth within the liquid photocurable resin from about 5 μm to about 250 μm (more typically from about 10 μm to about 100 μm or from about 10 μm to about 60 μm). This process is repeated in a layer-by-layer manner until the part is built.

More specifically, in the present example a 16 channel fluid directing body is printed using a Titan 3 printer from Kudo 3D using a liquid photocurable Custom Resin having the following formulation: 98.4 wt % polyethylene glycol diacrylate hydrogel, e.g., PEGDA-250 from Sigma-Aldrich or PEGDA-200 from Polysciences, Inc.; 1 wt % phenylbis(2,4,6-trimethylbenzoyl)phosphine oxide, e.g., Irgacure 819 photoinitiator from Sigma Aldrich (Cas No. 162881-26-71, peak absorption 295 nm or 370 nm); and 0.6% wt % 2-nitrophenyl phenyl sulfide (NPS) photoblocker from TCI America (Cas No. 4171-83-9, peak absorption 360 nm).

The formulation of the resin to some degree controls what wavelength and power density over a given layer thickness that can be reliably printed with good layer-to-layer adhesion during the build. Furthermore, selecting a material and layer thickness can have an impact on the size of microfluidic channels that can be generated in the plane of the cross-sectional area of the microfluidic channels during the build (relative to the direction of fluid flow), as the microfluidic channels often include sections that transect the material layers and other sections that run parallel to the material layers. Controlling the direction and depth of penetration of the laser while curing each layer of the microfluidic flow cell array can also play a role in how the part is 3D modeled and/or printed. Essentially, a laser wavelength is selected for use at a given power density and dwell time that is sufficient to photo cure each layer of the part so that the layers become fused to one another.

In this example, targeting a 10 μm layer thickness and using Custom Resin described above, a laser is used having a narrow band UV wavelength having a peak wavelength of about 385 nm and a 37 μm laser spot size (corresponding to print resolution). The total energy applied is based on the lamp output*exposure time/exposed area, which is typically from about 35 mJ/cm² to about 145 mJ/cm². In this particular example, the light engine applied from the laser to the individual layers was from about 40-70 mJ/cm², and more typically from about 45-50 mJ/cm².

When modeling for the build, care was taken so that the microfluidic channel regions did not receive enough light energy from the UV laser to cure the liquid photocurable resin in those areas. This was accomplished, for example, by i) avoiding focusing the UV laser at the microfluidic channels where practical, e.g, when building around microfluidic channels that perpendicularly transected the material layers, and ii) only penetrating individual material layers adjacent to microfluidic channels running parallel with the material layers at a depth that UV laser energy did not penetrate the microfluidic channels there above (or if some penetration did occur, the power density was insufficient to cure the photocurable resin with the microfluidic channel). It is estimated that the three-dimensional fluid directing body that was built as shown in FIG. 4 had about 8,000 layers, providing a part having a length of about 8 cm.

After the fluid directing body was fully printed and removed from beneath the build platform, the fluid directing body was coated with an epoxy to strengthen the exterior of the part and to reduce the possibility of cracking at the surface. The epoxy coated fluid directing body was then post cured using UV-LED light having a wavelength range from about 340 nm to about 420 nm and a power density or power level of about 15 mW/cm² to about 60 mW/cm² for about 0.5 second to about 60 seconds.

### Example 2—Assembling Microfluidic Flow Cell Arrays

The fluid directing body of Example 1 was used to attach to a contact deposition seal formed from polydimethyl siloxane (PDMS), which is softer than the material used to build the fluid directing body. The contact deposition seal was applied to a fluid directing body attachment surface of the fluid directing body that defines terminating ends (or needle-like openings) of multiple pairs of microfluidic channels. The contact deposition seal in this example was prepared conventionally, by patterning 16 rectangular flow chambers designed to fit over microfluidic flow pairs at their terminating ends. The contact deposition seal is fabricated from post-cure PDMS (polydimethylsiloxane) shrinkage to facilitate accurate alignment, with the material surrounding the pairs of terminating ends. More specifically, an SU-8 photomask is formed using an Electromask MM250 Criss Cross pattern generator. The SU-8 photoresist is spun to a thickness of 100 μm and patterned using a Suss/Microtech MA 1006. After development and post bake processing, the SU-8 features of the contact deposition seal are coated with fluorosilanizing agent (tridecafluoro-1,1,2,2-tetrahydrooctyl) triethoxysilane to facilitate release from the mold. The PDMS is mixed at a ratio of 10:1 and degassed for 1 hour. The PDMS is then placed in the mold and cured at 90° C. for one hour, and then removed from the mold. The contact deposition seal that is formed is then bonded to the fluid directing body with the flow chambers positioned about individual pairs of terminating ends of the pairs of microfluidic channels.

In this example, after forming the contact deposition seal conventionally, the contact deposition seal and the fluid directing body attachment surface were both further prepared by activating the opposing surfaces with oxygen plasma and then washing the surfaces with 3-(trimethoxysilyl)propyl methacrylate. The seal attachment surface was glued to the fluid directing body attachment surface using an epoxy. Alignment is adjusted (as needed) via visual inspection. See FIG. 4 to illustrate alignment. More specifically, the process of applying glue and alignment can be carried out by stamping epoxy on the seal attachment surface by spreading a thin layer of epoxy on a glass slide or flat piece of plastic, and then pressing the seal attachment surface onto the thin layer of epoxy. The seal attachment surface is aligned appropriately with the fluid directing body attachment surface with the assistance of a microscope. Once joined and aligned properly with the epoxy, the microfluidic flow cell array as a whole is cured again with a UV light source, which in this instance, was the same UV light source used to cure the epoxy coated fluid directing body.

It is noted that the contact deposition seal could alternatively be prepared by a separate three-dimensional printing process for subsequent attachment, similar to the way the conventionally prepared contact deposition seal was attached in this example, using the same material used to prepare the fluid directing body or alternatively by using a second (different) material. In other examples, the three-dimensional printing process could utilize a second (different) material and directly print the contact deposition seal portion onto the fluid directing body attachment surface prepared using a first material, e.g., using a second liquid photocurable resin bath with an appropriate laser source to continue printing the microfluidic flow cell array with a second material. Alternatively, the three-dimensional printing process could likewise be continued using the same material all the way through formation of the contact deposition seal.

### Example 3—Polyjet Printing of Microfluidic Flow Cell Arrays

A microfluidic flow cell array similar to that shown in FIG. 3 is printed using a Stratasys MED610 polyjet printing process with a bottom-up printing orientation. The polyjet printing process is similar to that shown in FIG. 1B, In this example, multiple fluid jet printheads are used to dispense small droplets of liquid photocurable resins of two different materials, referred to as a first build material and a second build material, in a layer-by-layer manner onto a build platform. In this example, the first build material is a thermoset resin with an aluminum nitride powder additive. The second build material is a thermoset resin without a powder additive. The first build material when cured results in a structure that is more thermally conductive than the second build material. Additionally, the first build material may have a different refractive index and/or stiffness relative to the second build material. Each layer of first and second build materials applied at different spatial volumes of the part is cured using UV light suitable to crosslink or otherwise cure the build material. The UV light is positioned overhead and may either be in a fixed position to flash the entire layer with the UV light, or may be positioned on a carriage along with the fluid jet printhead. Furthermore, the UV light penetrates each layer sufficiently to cause adjacent layers to become crosslinked to one another. The first build material and the second build material are compatible to the extent that when cured using UV light, the two materials become sufficiently adhered to one another to provide part stability even at the interface where the two materials are adjacent to one another. Notably, in some instances, it may be desirable to use two different UV light sources if the first build material and the second build material have better curing properties when exposed to sufficiently different UV wavelengths of energy. In this example, the fluid directing body and the contact deposition seal are formed as a single build using two different build materials. For example, the first build material can be used to form the fluid directing body and a second build material can be used to form the contact deposition seal. In some examples, the second build material can likewise be used as part of the fluid directing body, such as to define areas around the source fluid openings, to form fluidic interfaces associated with the source fluid openings, or at various locations at or around microfluidic channels or portions thereof.

As part of the build, a support material (or sacrificial material) is also ejected onto the microfluidic flow cell array at locations that will ultimately provide negative space within the part, e.g., microfluidic channels, source fluid opening openings, terminating end openings (immediately adjacent to the contact deposition seal), deposition seal channels, and flow chambers. The support material is a temporary material that typically is removed, leaving the negative space to provide microfluidic channel fluid flow. In this example, the support material selected for use is SUP705, from Stratasys, which is a water-soluble polymer including 10-30 wt % polyethylene glycol 400, 10-30 wt % 1,2-propanediol, 10-30 wt % 1,2,3-propanetriol, 3-10 wt % acrylic acid, and small concentrations of a few additives (e.g., less than about 0.3 wt % per additive). The support material is a polymer that is readily water-soluble, making it removable by injecting water through the various microfluidic channels.

### Example 4—Polyjet Printing of Fluid Directing Bodies and Assembly of Microfluidic Flow Cell Arrays

The same process of Example 3 is followed, except the three-dimensional printing process is used to form the fluid directing body without the contact deposition seal. In this example, the fluid directing body is attached to the contact deposition seal in the same way as described in Example 2. Furthermore, multiple pairs of fluidic interfaces are also attached to corresponding pairs of microfluidic channel source fluid openings also using the same process as described in Example 2. Notably, the contact deposition seal and the pairs of fluidic interfaces can be prepared separately by three-dimensional printing or may be prepared conventionally.

### Example 5—Inclusion of Conductive Materials within Microfluidic Flow Cell Arrays

A microfluidic flow cell array prepared in accordance with Example 3 is prepared to include auxiliary channels in addition to the pairs of microfluidic channels of the various flow cells. The auxiliary channels are also prepared to contain a temporary support material that is removed, leaving negative space for the inclusion of a conductive material. The auxiliary channels are filled with a low melting point metal, such as gallium or Galinstan (Ga—In—Sn), or a binary eutectic alloy, e.g. Sn—Pb, EGaln, e.g., or a ternary eutectic alloy, e.g., Sn—Ag—Cu, which is suitable for providing any of a number of functions, such as thermal conductivity, electrical conductivity, resistive conductivity to generate heat, etc.

It is noted that in other examples, rather than filling negative space left by vacated support material with a conductive substance, the conductive substance may alternatively be printed within the microfluidic flow cell array while the build layers are being applied. In this example, a first material may be a thermoset resin to form a major bulk of the microfluidic flow cell array, and a second material including the thermoset resin with conductive or semi-conductive particles dispersed therein can form various conductive or semi-conductive elements as part of the microfluidic flow cell array. Example particles that can be used include elemental metal particles, e.g., silver, aluminum, gold, etc.; carbon nanotubes; metal salts to be subsequently reduced to form metal particles; Mxenes or Mxene composites; etc. Thus, the conductive substance can be printed directly within layers of the microfluidic flow cell array.

### Example 6—Stereolithography Printing (SLP) Printing Parameters and Microfluidic Channel Size and Quality

Multiple fluid directing bodies were printed using an SLP printing process similar to that described in Example 1. More specifically, 16 channel fluid directing bodies were printed using a Titan 3 printer from Kudo 3D. The build material selected for this example was a liquid photocurable Custom Resin, having the following formulation: 98.4 wt % PEGDA-250 (Sigma-Aldrich), 1 wt % Irgacure 819 photoinitiator (Sigma Aldrich), and 0.6% wt % 2-nitrophenyl phenyl sulfide photoblocker. The layer thickness for this build was selected at about 10 μm and the energy (intensity and dwell time) applied to each voxel of each layer using a narrow band UV laser having a peak UV wavelength of about 385 nm. Notably, the Titan 3 printer allows for adjustment relative to the light engine positioning and laser energy focus, providing the possibility of varying the XY resolutions, e.g., ranging from about 25 μm to about 100 μm. When adjusting the XY resolution (or spot size of applied energy from the laser), the energy intensity and/or dwell time of the laser light may be calibrated to achieve appropriate exposure of the build material to photocure the individual layers of build material.

In this example, two fluid directing bodies were formed with target microfluidic channel cross-sectional length or diameter of about 300 μm. A first fluid directing body was formed using a narrow band UV laser having a peak wavelength of about 385 nm and a 37 μm laser spot size (corresponding to print resolution). For comparison, a second fluid directing body was formed using a narrow band UV laser having a peak wavelength of about 385 nm and a 100 μm laser spot size (corresponding to print resolution). The total energy applied to expose each layer in both examples was about 40-70 mJ/cm². The first fluid directing body formed functional microfluidic channels having a square cross-sectional shape as modeled. On the other hand, the second fluid directing body also formed functional microfluidic channels, but the cross-sectional shape of the microfluidic channels had more of a trapezoidal shape.

Regarding the build material used to prepare the fluid directing bodies with 300 μm cross-sectional diameters, a lower concentration of the photoblocker (2-nitrophenyl phenyl sulfide) was used, i.e. 0.6 wt % compared to other formulations because the microfluidic channels being formed were targeted to be relatively large. When the objective is to prepare smaller microfluidic channels, e.g., below about 50 μm, a higher concentration of photoblocker may be used, e.g., about 1 wt % to about 3 wt %. However, the tradeoff of using more photoblocker to achieve narrower functional microchannels may lead to softer parts with less part consistency, e.g., due in part to less UV laser penetration. By reducing the concentration of photoblocker to less than about 1 wt %, e.g., 0.6 wt %, very consistent fluid directing bodies and/or microfluidic flow cell arrays can be formed having microfluidic channels with cross-sectional diameters from about 150 μm to about 500 μm using this process, as demonstrated by the 300 μm microfluidic channels prepared in this example at both a 37 μm and a 100 μm XY print resolution.

### Example 7—Fluid Flow Analysis Through Microfluidic Channels Prepared by Three-Dimensional Printing Processes

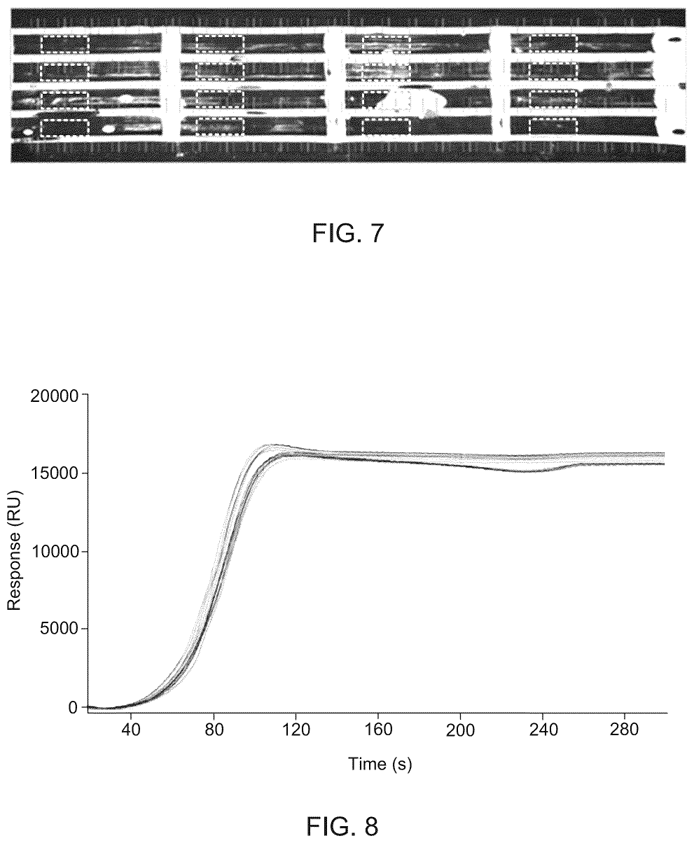

Several fluid flow analyses were conducted on several different microfluidic flow cell arrays to determine if their 16 microfluidic channels could consistently be filled with deionized water and then injected with a salt solution of 10% w/v NaCl to determine whether the salt could effectively pass through all 16 of the microfluidic channels and be detected at the various regions of interest (ROI). Injection refers to the changing of the fluid sample from a deionized water source to a 10% w/v NaCl water source. A consistent flow rate of the deionized water followed by the salt solution was set and the data collected. To illustrate an example testing protocol, FIG. 7 is an image of a 16 channel microfluidic flow cell array viewed from its contact deposition seal when pressed against a sensor surface (viewed through the sensor surface with water thereon). The essentially solid (but imperfect) white lines are where the contact deposition seal is pressed against the sensor surface. The white irregular shapes are temporary air bubbles within the system. The dotted rectangular areas represent 16 evenly spaced ROI, which is the point of data acquisition.

Referring to FIG. 8, this graph illustrates data collected from the 16 evenly spaced ROI. The graph provides time in seconds against response units (RU), which are refractive index units. The relative units illustrate the point and are thus unites in this example. In this example, once the deionized water was flowing, the salt was injected and began to be detectible at all 16 microfluidic channels just after about 40 seconds. At a point in time prior to about 120 seconds, all 16 microfluidic channels exhibited greater than about 15000 RU. Some of the 16 microfluidic channels settled in at about 16,000 RU in this example. For comparison, the target or expected response unit value based on the model was about 17,200 RU. As the salt solution continued to flow, those RU values remained relatively stable. In this particular example, once a portion of the salt started to be detected at the other end of the microfluidic channels, it took an average of about 60 seconds for the peak concentration of the salt solution to reach the sensor where the ROI were located. As a note, the start time of the injection of the salt solution can be varied from test to test. What is being shown is that the salt solution passes through the microfluidic channels at relatively even volumes within a similar time frame for a similar set of microfluidic channels.

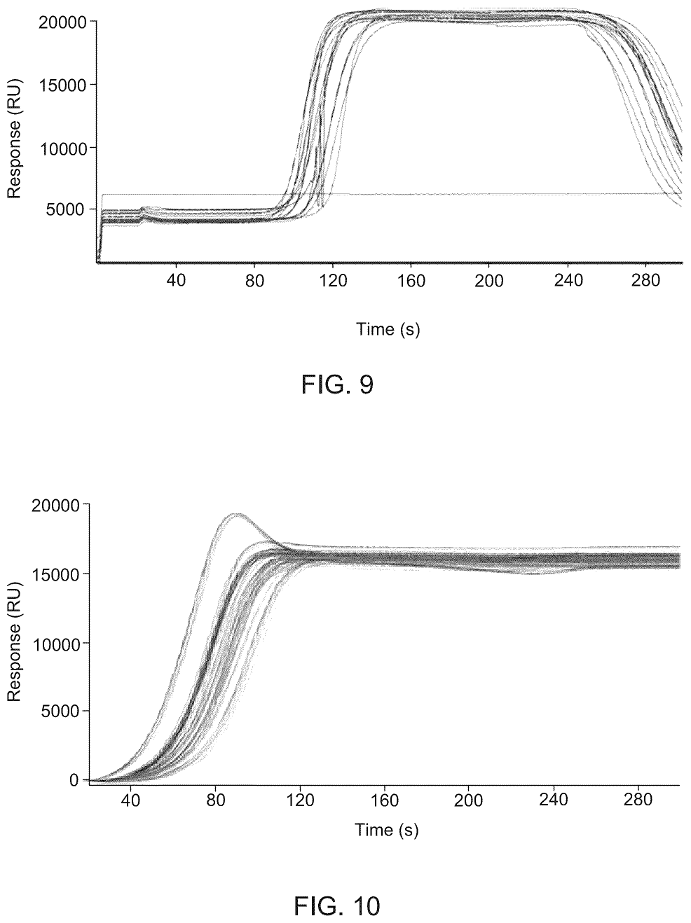

The data collected related to FIG. 9 was carried out in the same manner as that described with respect to FIG. 8; however, in this example, the injection of the salt solution only occurred for 60 seconds and then the deionized water was then reconnected for continued flow. In this particular example, once a portion of the salt started to be detected at the other end of the microfluidic channels, e.g., on average at about the 105 seconds time marker, it took an average of about 20 seconds for the peak concentration of the salt solution to reach the sensor where the ROI were located. Since the salt was injected for only about 60 seconds, at an average point in time of about 255 seconds, the peak concentration of the salt solution began to taper off to initial levels, i.e. prior to the 60 second injection of the salt solution.

Referring now to FIG. 10, instead of using 16 evenly spaced ROI as shown in FIG. 7, in this example, the data was collected from 287 ROI positioned about the surface of the sensor within the 16 flow cell chambers. Again, after flowing deionized water, the source was switched to 10 w/v NaCl. The data collected produced a curve consistent with that shown in FIG. 8, but with many more data points.

1. A microfluidic flow cell array defining a plurality of flow cells, comprising:
a fluid directing body including multiple layers of three-dimensionally printed material, the fluid directing body defining:
a first pair of microfluidic channels that individually transect a portion of the multiple layers and also redirect fluid flow when within the fluid directing body, and
a second pair of microfluidic channels that individually transect a portion of the multiple layers and also redirect fluid flow when within the fluid directing body,
a contact deposition seal adapted to contact a deposition surface and deliver fluid thereto, the contact deposition seal defining a first flow chamber and a second flow chamber, wherein the first flow chamber is fluidly coupled to adjacent terminating ends of the first pair of microfluidic channels forming a first flow cell, and the second flow chamber is fluidly coupled to adjacent terminating ends of the second pair of microfluidic channels forming a second flow cell.

2. The microfluidic flow cell array of claim 1, wherein the fluid direction body and the contact deposition seal are of the same material.

3. The microfluidic flow cell array of claim 1, wherein the fluid directing body includes a first material and the contact deposition seal includes a second material, wherein:
the second material is softer than the first material;
the first material has higher thermal conductivity and heat capacity than the second material;
the first material has a different optical absorbance or different refractive index than the second material;
the first material has a higher optical absorbance or higher refractive index than the second material; or
a combination thereof.

4-10. (canceled)

11. The microfluidic flow cell array of claim 1, wherein the deposition surface to be contacted is an assay to sense surface plasmon resonance.

12. The microfluidic flow cell array of claim 1, wherein the first pair of microfluidic channels include individual microfluidic channels having a roughness from about 1 μm to about 10 μm at a region where the individual microfluidic channels transect the multiple layers.

13. The microfluidic flow cell array of claim 1, wherein the fluid directing body includes both a first material and a second material that is positioned adjacent to the first material.

14. The microfluidic flow cell array of claim 13, wherein the first material defines the first pair of microfluidic channels, and wherein the second material is positioned between individual microfluidic channels of the first pair of microfluidic channels or the second material defines a first pair of integrated gaskets about a first pair of source fluid openings.

15-16. (canceled)

17. The microfluidic flow cell array of claim 13, wherein the first material defines the first pair of microfluidic channels, aid a first pair of source fluid openings thereof is coupled to a first pair of fluidic interfaces, and the first pair of fluidic interfaces is selected from integrated fluid wells, luer connectors, removable plugs, pipette adaptors, syringe adaptors, needle adaptors, fluidic through-holes, nanoport assemblies, fluidic seals, fluidic valves, bulk fluidic port, air control ports, fluid sample ports, waste ports, or a combination thereof.

18-19. (canceled)

20. The microfluidic flow cell array of claim 13, wherein:
the first material defines a portion of the first pair of microfluidic channels immediately adjacent to the contact deposition seal, or
the first material defines the first pair of microfluidic channels and the second pair of microfluidic channels, and wherein the second material is positioned between the first pair of microfluidic channels and the second pair of microfluidic channels.

21. (canceled)

22. The microfluidic flow cell array of claim 13, wherein the first pair of microfluidic channels is defined by the first material, and wherein:
the second pair of microfluidic channels is defined by the second material;
the second material is shaped as elongated structure that runs parallel with the first pair of microfluidic channels, the second pair of microfluidic channels, or both.

23-24. (canceled)

25. The microfluidic flow cell array of claim 23, wherein:
the elongated structure does not define interior surfaces of the first pair of microfluidic channels, but is positioned within 2 mm of an interior of one or both of the first pair of microfluidic channels, or
the elongated structure is sufficiently close to interact with a fluid carried by the first pair of microfluidic channels thermally, electrically, optically.

26. (canceled)

27. The microfluidic flow cell array of claim 13, wherein the fluid directing body includes an outer shell and an inner core, wherein at least a portion of the outer shell includes the second material and the inner core that defines a majority of the first pair of microfluidic channels and the second pair of microfluidic channels includes the first material.

28-29. (canceled)

30. The microfluidic flow cell array of claim 1, further comprising a first auxiliary channel running in parallel with at least a portion of the first pair of microfluidic channels at a location to interact with fluid carried by the first pair of microfluidic channels.

31. The microfluidic flow cell array of claim 30, wherein the first auxiliary channel is filled with a gas, a liquid, a liquid or solid metal, a conductor, a semi-conductor, an insulator, an electronics component, an optical component, a chemical reagent, or a combination thereof, or wherein the first auxiliary channel is a thermal control channel containing or to contain heated or cooled fluid.

32-38. (canceled)

39. The microfluidic flow cell array of claim 1, wherein the microfluidic flow cell array is adapted to insert into a flow cell applicator assembly without a cartridge.

40. The microfluidic flow cell array of claim 1, wherein the microfluidic flow cell array is adapted to insert into a cartridge for insertion into a flow cell applicator assembly.

41. The microfluidic flow cell array of claim 1, including a first material and a second material that is positioned adjacent to the first material.

42. The microfluidic flow cell array of claim 1, wherein:
the first material has higher thermal conductivity or heat capacity than the second material,
the first material has higher stiffness than the second material,
the first material has higher optical absorbance or optical refractive index than the second material,
the first material has a higher electrical conductivity than the second material,
the first material has a higher chemical resistance to at least one solvent selected from isopropyl alcohol, DMSO, or acetone compared to the second material, or
a combination thereof.

43-45. (canceled)

46. The microfluidic flow cell array of claim 42, wherein the first material has an elasticity (or stiffness) from 0.1 GPa to 5 GPa and the second material has an elasticity (or stiffness) from 0.1 MPa to 50 MPa.

47. (canceled)

48. The microfluidic flow cell array of claim 42, wherein:
the first material has an optical absorbance of less than 0.1 in a visible or near IR wavelength and the second material has an optical absorbance of 0.1 or greater at the visible or near IR wavelength; or
the first material has an optical refractive index from 1.3 to 1.5 and the second material has an optical refractive index from 1.5 to 1.9.

49. (canceled)

50. The microfluidic flow cell array of claim 42 the first material and the second material are positioned relative to one another to form an optical waveguide within the fluid directing body, the contact deposition seal, or both.

51. The microfluidic flow cell array of claim 50, wherein the optical waveguide is;
positioned to make a measurement within the fluid directing body, within the contact deposition seal, at a deposition surface before, after, or in contact with the deposition seal, or a combination thereof;
adapted to deliver light to the first pair of microfluidic channels, the first flow chamber, a deposition surface before, after, or in contact with the deposition seal, or a combination thereof; or
adapted to deliver light to generate an optical change in the microfluidic flow cell array, a deposition surface before, after, or in contact with the deposition seal, or a combination thereof.

52-55. (canceled)

56. The microfluidic flow cell array of claim 42, wherein:
the first material has an electrical conductivity from 10⁻¹⁶ S/m to 10⁻¹² S/m and the second material has an electrical conductivity from 10⁻⁷ S/m to 10⁸ S/m,
the second material defines the first pair of microfluidic channels, and the first material is positioned at or adjacent to the contact deposition seal,
the first material in the form of an electrical element selected from a wire, a heater, an actuator, or a sensing element,
the first material is in the form of a sensing element capable of measuring the conductivity of a fluid within the first flow cell,
the first material is in the form of an electrical element capable of generating an electric field across a fluid within the first flow cell,
the first material is in the form of an electrical element capable of generating an electric field across a fluid within the first flow cell and the electric field enables retention of charged or dielectric particles within the flow cell,
the first material is in the form of an electrical element capable of causing an electrolytic reaction to within the first flow cell, or
the electrolytic reaction is capable of forming a bubble within the first flow cell.

57-64. (canceled)

65. The microfluidic flow cell array of claim 41, wherein the first material is three-dimensionally printed and the second material is not three-dimensionally printed.

66. The microfluidic flow cell array of claim 1, wherein the first pair of microfluidic channels include a first pair of source fluid openings for fluid delivery or removal.

67. The microfluidic flow cell array of claim 66, wherein individual source fluid openings of the first pair of source fluid openings are on different surfaces of the fluid directing body, or wherein the second pair of microfluidic channels include a second pair of source fluid openings for fluid delivery or removal, and wherein the first pair of source fluid openings are on a different surface of the fluid directing body than the second pair of source fluid openings.

68. The microfluidic flow cell array of claim 1, wherein the first pair of microfluidic channels include cross-sectional shapes perpendicular to a direction of fluid flow selected from round, oval, elliptical, trapezoidal, triangular, rectangular, or square.

69. The microfluidic flow cell array of claim 1, wherein the first pair of microfluidic channels include a cross-sectional shape that changes along its length in a direction of fluid flow.

70. (canceled)

71. The microfluidic flow cell array of claim 1, wherein:
the cross-sectional area of the first pair of microfluidic channels is different than the cross-sectional area of the second pair of microfluidic channels,
the cross-sectional area of the first pair of microfluidic flow channels and the second pair of microfluidic flow channels both vary along their lengths thereof, or
the cross-sectional area of the first pair of microfluidic flow channels vary multiple times along their length thereof.

72-73. (canceled)

74. The microfluidic flow cell array of claim 1, comprising from 3 to 768 flow cells which includes the first flow cell and the second flow cell.

75. (canceled)

76. The microfluidic flow cell array of claim 1, wherein the first pair of microfluidic channels include flow paths along multiple parallel planes within the fluid directing body.

77. The microfluidic flow cell array of claim 1, wherein the first pair of microfluidic channels and the second pair of microfluidic channels have the same flow resistance relative to a common fluid.

78. The microfluidic flow cell array of claim 1, wherein the first pair of microfluidic channels are defined in part by a flow modification structure that promotes mixing, circulation, diffusion of fluids, flow velocity, flow uniformity, flow efficiency, or a combination thereof, wherein the flow modification structure is selected from a bump, ridge, recess, 3D pattern, angled surface, chevron shape, or a combination thereof.

79. (canceled)

80. The microfluidic flow cell array of claim 1, wherein the fluid directing body includes an alignment structure adapted to be joined with a corresponding alignment structure of the contact deposition seal, wherein the alignment structure includes a pin, a pin-receiving opening, a tab, a tab-receiving opening, a bump a bump-receiving opening, a cutout, or combination thereof.

81-83. (canceled)

84. The microfluidic flow cell array of claim 1, wherein the fluid directing body or the contact deposition seal is adapted to:
be punctured or otherwise rendered inoperable by a flow cell applicator system or device carrying the microfluidic flow cell array, or
communicate with a flow cell applicator system or device after the microfluidic flow cell array is spent, rendering the microfluidic flow cell array inoperable either by software instructions or the flow call applicator system or device destroying the microfluidic flow cell array.

85. (canceled)

86. The microfluidic flow cell array of claim 84, wherein the microfluidic flow cell array is determined to be spent based on a certain number of uses or a certain amount of time, or is determined to be spent based on a certain number of uses or a certain amount of time as determined by indicia located on the microfluidic flow cell array or associate chip.

87. (canceled)

88. The microfluidic flow cell array of claim 41, wherein the first material and the second material independently include a material selected from the group consisting of silicon, silica, gallium arsenide, glass, ceramic, quartz, neoprene, urethane, polyethylene glycol diacrylate, polytetrafluorethylene, perfluoroalkoxy polymer, fluorinated ethylene propylene polymer, tetrafluoroethylene copolymer, polybutadiene/styrene-butadiene, polyethylene terephthalate, nitrile polymer, polydimethylsiloxane, polylactic acid, acrylonitrile butadiene styrene, polyamide, polyvinyl alcohol, thermoplastic elastomer, and a combination thereof.

89. The microfluidic flow cell array of claim 41, wherein the first material is a polymeric material that is three-dimensionally printed, and the second material is non-polymeric material.

90. (canceled)

91. A flow cell applicator system, comprising:
a microfluidic flow cell array defining a plurality of flow cells, comprising:
a fluid directing body including multiple layers of three-dimensionally printed material, the fluid directing body defining a first pair of microfluidic channels that individually transect a portion of the multiple layers and also redirect fluid flow when within the fluid directing body, and a second pair of microfluidic channels that individually transect a portion of the multiple layers and also redirect fluid flow when within the fluid directing body,
a contact deposition seal adapted to contact a deposition surface and deliver fluid thereto, the contact deposition seal defining a first flow chamber and a second flow chamber, wherein the first flow chamber is fluidly coupled to adjacent terminating ends of the first pair of microfluidic channels forming a first flow cell, and the second flow chamber is fluidly coupled to adjacent terminating ends of the second pair of microfluidic channels forming a second flow cell.
a fluid applicator assembly couplable or coupled to the microfluidic flow cell array to deliver fluid to a deposition surface through the microfluidic flow cell array.

92. The flow cell applicator system of claim 91, wherein the fluid applicator assembly includes a positioner to position, dock, and undock the microfluidic flow cell array for fluid delivery while docked.

93. The flow cell applicator system of claim 91, further comprising:
a second microfluidic flow cell array, wherein the fluid applicator assembly is also couplable or coupled to the second microfluidic flow cell array to delivery fluid to the deposition surface through the second microfluidic flow cell array;
a large flow cell applicator, wherein the fluid applicator assembly is also couplable or coupled to the large flow cell applicator to delivery fluid to the deposition surface through the large flow cell applicator: or
both.

94. (canceled)

95. The flow cell applicator system of claim 93, wherein the large flow cell applicator is also at least partially three-dimensionally printed.

96. The flow cell applicator system of claim 91, further comprising a cartridge configured to receive the microfluidic flow cell array and to interface with the fluid applicator assembly.

97. The flow cell applicator system of claim 96, wherein the microfluidic flow cell array includes alignment features corresponding to a configuration of the cartridge.

98. The flow cell applicator system of claim 96, wherein the microfluidic flow cell array and the cartridge are both three-dimensionally printed at least in part.

99. The flow cell applicator system of claim 91, wherein the microfluidic flow cell array includes a self-destructing component so that it can only be used one time or a specific number of times or for a specific time period before the microfluidic flow cell array is rendered inoperable.

100. The flow cell applicator system of claim 91, further comprising a deposition surface.

101. The flow cell applicator system of claim 100, wherein the deposition surface is an assay surface associated with a sensor to optically sense surface plasmon resonance or to movement of the fluid applicator assembly.

102-104. (canceled)

105. A method of manufacturing a microfluidic flow cell array, comprising forming at least a portion of the microfluidic flow cell array by a three-dimensional printing method, and wherein the microfluidic flow cell array defines at least two flow cells, wherein individual flow cells include a pair of microfluidic channels and a flow chamber fluidly coupled to adjacent terminating ends of the pair of microfluidic channels.

106. The method of claim 105, wherein the microfluidic flow cell array includes a fluid directing body that defines the multiple pairs of microfluidic channels, and also includes a contact deposition seal that defines multiple corresponding flow chambers.

107. The method of claim 106, wherein;
the fluid directing body is formed by the three-dimensional printing,
the contact deposition seal is formed by the three-dimensional printing,
both fluid directing body and the contact deposition seal are formed by three-dimensional printing and then joined together, or
both fluid directing body and the contact deposition seal are formed by a single three-dimensional printing process.

108-110. (canceled)

111. The method of claim 105, wherein:
the three-dimensional printing process includes application of multiple materials such that the microfluidic flow cell array has discrete portions of individual materials of the multiple materials,
the three-dimensional printing process includes stereolithography printing, or
the three-dimensional printing process includes polyjet printing.

112-113. (canceled)

114. The method of claim 105, wherein the three-dimensional printing process includes digital light process printing, selective laser sintering, fused deposition modeling, direct metal layer sintering, electron beam melting, binder jetting, powder bed fusion, directed energy deposition, or sheet lamination of fused deposition modeling.

115. The method of claim 114, further comprising forming the microfluidic flow cell array includes forming alignment features therein that provide for alignment or attachment to a cartridge that is connected or connectable to a flow cell applicator assembly, forming the cartridge by three-dimensional printing, or both.

116. (canceled)
